(19) United States
(12) Patent Application Publication
(10) Pub. No.: US 2026/0231181 A1
(43) Pub. Date: Aug. 6, 2026

(54) REDUCED COMPLEXITY SIGNALS FOR UPLINK

(71) Applicant: QUALCOMM Incorporated, San Diego, CA (US)

(72) Inventors: Alexander SVERDLOV, Rehovot (IL); Michael LEVITSKY, Rehovot (IL); Gideon Shlomo KUTZ, Ramat Hasharon (IL); Amit BAR-OR TILLINGER, Tel-Aviv (IL); Daniel PAZ, Atlit (IL); Assaf TOUBOUL, Netanya (IL)

(21) Appl. No.: 19/046,107

(22) Filed: Feb. 5, 2025

(51) Int. Cl. H04W 72/25; H04B 7/0456; H04W 72/0453

(52) U.S. Cl. CPC H04W 72/25; H04B 7/0456; H04W 72/0453

(57) ABSTRACT

Various aspects of the present disclosure generally relate to wireless communication. In some aspects, a user equipment (UE) may transmit, to a network entity via an access link, a first set of signals associated with a data set. The UE may transmit, to a wireless device via a sidelink, precoding information and a second set of signals that includes a plurality of repetitions associated with the data set. Numerous other aspects are described.

### FIELD OF THE DISCLOSURE

Aspects of the present disclosure generally relate to wireless communication and specifically relate to techniques, apparatuses, and methods associated with reduced complexity signals for uplink.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

Some aspects described herein relate to a method of wireless communication performed by a wireless device. The method may include receiving precoding information. The method may include receiving, from a user equipment (UE) via a sidelink, a set of signals that includes a plurality of repetitions of a data set. The method may include forwarding the set of signals to a network entity using the precoding information.

Some aspects described herein relate to a method of wireless communication performed by a network entity. The method may include receiving, from a UE via an access link, a first set of signals associated with a data set. The method may include receiving, from a wireless device via a sidelink, a second set of signals that include a plurality of repetitions associated with the data set. The method may include perform combined demodulation, based at least in part on precoding information, of the first set of signals and the second set of signals to generate the data set.

Some aspects described herein relate to a UE. The UE may include a processing system. The processing system may include one or more processors and one or more code-storing memories coupled with the one or more processors. The processing system may be configured to cause the UE to transmit, to a network entity via an access link, a first set of signals associated with a data set. The processing system may be configured to cause the UE to transmit, to a wireless device via a sidelink, precoding information and a second set of signals that includes a plurality of repetitions associated with the data set.

Some aspects described herein relate to a wireless device. The wireless device may include a processing system. The processing system may include one or more processors and one or more code-storing memories coupled with the one or more processors. The processing system may be configured to cause the wireless device to receive precoding information. The processing system may be configured to cause the wireless device to receive, from a UE via a sidelink, a set of signals that includes a plurality of repetitions of a data set. The processing system may be configured to cause the wireless device to forward the set of signals to a network entity using the precoding information.

Some aspects described herein relate to a network entity. The network entity may include a processing system. The processing system may include one or more processors and one or more code-storing memories coupled with the one or more processors. The processing system may be configured to cause the network entity to receive, from a UE via an access link, a first set of signals associated with a data set. The processing system may be configured to cause the network entity to receive, from a wireless device via a sidelink, a second set of signals that include a plurality of repetitions associated with the data set. The processing system may be configured to cause the network entity to perform combined demodulation, based at least in part on precoding information, of the first set of signals and the second set of signals to generate the data set.

Some aspects described herein relate to a non-transitory computer-readable medium that stores a set of instructions for wireless communication by a UE. The set of instructions, when executed by one or more processors of the UE, may cause the UE to transmit, to a network entity via an access link, a first set of signals associated with a data set. The set of instructions, when executed by one or more processors of the UE, may cause the UE to transmit, to a wireless device via a sidelink, precoding information and a second set of signals that includes a plurality of repetitions associated with the data set.

Some aspects described herein relate to a non-transitory computer-readable medium that stores a set of instructions for wireless communication by a UE. The set of instructions, when executed by one or more processors of the UE, may cause the UE to transmit, to a network entity via an access link, a first set of signals associated with a data set. The set of instructions, when executed by one or more processors of the UE, may cause the UE to transmit, to a wireless device via a sidelink, precoding information and a second set of signals that includes a plurality of repetitions associated with the data set.

Some aspects described herein relate to a non-transitory computer-readable medium that stores a set of instructions for wireless communication by a wireless device. The set of instructions, when executed by one or more processors of the wireless device, may cause the wireless device to receive precoding information. The set of instructions, when executed by one or more processors of the wireless device, may cause the wireless device to receive, from a UE via a sidelink, a set of signals that includes a plurality of repetitions of a data set. The set of instructions, when executed by one or more processors of the wireless device, may cause the wireless device to forward the set of signals to a network entity using the precoding information.

Some aspects described herein relate to a non-transitory computer-readable medium that stores a set of instructions for wireless communication by a network entity. The set of instructions, when executed by one or more processors of the network entity, may cause the network entity to receive, from a UE via an access link, a first set of signals associated with a data set. The set of instructions, when executed by one or more processors of the network entity, may cause the network entity to receive, from a wireless device via a sidelink, a second set of signals that include a plurality of repetitions associated with the data set. The set of instructions, when executed by one or more processors of the network entity, may cause the network entity to perform combined demodulation, based at least in part on precoding information, of the first set of signals and the second set of signals to generate the data set.

Some aspects described herein relate to an apparatus for wireless communication. The apparatus may include means for transmitting, to a network entity via an access link, a first set of signals associated with a data set. The apparatus may include means for transmitting, to a wireless device via a sidelink, precoding information and a second set of signals that includes a plurality of repetitions associated with the data set.

Some aspects described herein relate to an apparatus for wireless communication. The apparatus may include means for receiving precoding information. The apparatus may include means for receiving, from a UE via a sidelink, a set of signals that includes a plurality of repetitions of a data set. The apparatus may include means for forwarding the set of signals to a network entity using the precoding information.

Some aspects described herein relate to an apparatus for wireless communication. The apparatus may include means for receiving, from a UE via an access link, a first set of signals associated with a data set. The apparatus may include means for receiving, from a wireless device via a sidelink, a second set of signals that include a plurality of repetitions associated with the data set. The apparatus may include means for performing combined demodulation, based at least in part on precoding information, of the first set of signals and the second set of signals to generate the data set.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example disaggregated network node architecture.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example of a relay user equipment (UE) that relays communications between a UE and a network node, in accordance with the present disclosure.

FIG. 6 is a diagram illustrating an example of a transmit chain and a receive chain of a UE, in accordance with the present disclosure.

FIG. 7 is a diagram of an example associated with uplink antenna augmentation using sidelink and companion devices, in accordance with the present disclosure.

FIG. 8A is a diagram illustrating an example associated with sidelink reception/transmission processing, in accordance with the present disclosure.

FIG. 8B is a diagram illustrating an example associated with a repetition scheme associated with sidelink reception/transmission processing, in accordance with the present disclosure.

FIG. 9 is a diagram illustrating an example associated with sidelink reception processing, in accordance with the present disclosure.

FIG. 10 is a diagram illustrating an example associated with FR2 and/or FR3 sidelink communications, in accordance with the present disclosure.

FIG. 11 is a diagram illustrating an example process performed, for example, at a UE or an apparatus of a UE.

FIG. 12 is a diagram illustrating an example process performed, for example, at a wireless device or an apparatus of a wireless device.

FIG. 13 is a diagram illustrating an example process performed, for example, at a network entity or an apparatus of a network entity.

FIG. 14 is a diagram of an example apparatus for wireless communication.

FIG. 15 is a diagram of an example apparatus for wireless communication.

### DETAILED DESCRIPTION

Some wireless communications systems may support device-to-device (D2D) communications. For example, a first user equipment (UE) and a second UE may communicate directly with one another using sidelink communications (for example, independently of a network node as an intermediary). As an example, the first UE may directly transmit data, control information, or other signaling as a sidelink communication to the second UE. In some deployments and configurations, a network node may schedule and/or allocate resources for sidelink communications between UEs. In some other deployments and configurations, a UE may perform, or collaborate or negotiate with one or more other UEs to perform, scheduling operations, resource selection operations, and/or other operations for sidelink communications. Sidelink data and control transmissions may use sidelink-specific channels such as a physical sidelink shared channel (PSSCH), a physical sidelink control channel (PSCCH), and/or a physical sidelink feedback channel (PSFCH).

Some wireless communications systems may support ultrawide bandwidth (UWB)-compliant sidelink communications, and/or licensed-band-compliant sidelink communications, such as FR2 band sidelink communications and/or FR3 band sidelink communications. UWB communications, FR2 communications, and/or FR3 communications may be more efficient, less affected by interference, and may be associated with greater power-saving benefits than some other technologies that may be applied to sidelink communications. UWB communications may be performed over a wide range of frequencies (e.g., ~3.1 GHz to ~10.6 GHz). In comparison to narrowband communication systems that use a single frequency or a narrow band of frequencies, UWB supports communications over a broad spectrum of frequencies, thereby increasing throughput, at very low power levels.

Other frequency bands have been defined as frequency range designations FR1 (410 MHz through 7.125 GHZ), FR2 (24.25 GHz through 52.6 GHz), and FR3 (7.125 GHz through 24.25 GHZ), among other examples. Although a portion of FR1 is greater than 6 GHZ, FR1 is often referred to (interchangeably) as a “sub-6 GHz” band. Similarly, FR2 is often referred to (interchangeably) as a “millimeter wave” band, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies.

UWB communications, FR2 communications, and/or FR3 communications may be used for communications between UEs and companion devices. Companion devices may include wearable UEs (e.g., fitness trackers, extended reality (XR) goggles and/or headsets, smartwatches, smart glasses, smart clothing, and/or personal medical monitors), smart home UEs, internet-of-things (IoT) devices, reduced capability (RedCap) UEs, and/or any other UE that supports or enhances the functionality of a primary UE. “Primary UE” refers to a main UE and/or a target UE that is performing a primary function (e.g., communicating, web browsing, messaging, system navigation, or any other interaction with a core functionality of the device) for a user and may be relative to the usage and type of interaction that the user has with the device.

UWB communications may be bounded by regulations, such as a minimum bandwidth usage (e.g., UWB communications may be performed via a bandwidth that is greater than or equal to the minimum bandwidth defined by UWB regulations), and/or a power spectral density (PSD) constraint. For example, any signal communicated via UWB may be communicated via a bandwidth that is equal to or greater than the minimum bandwidth (e.g., 500 MHz or greater), and/or a transmit power of the signal may be distributed over the bandwidth use (e.g., may not exceed the PSD constraint). However, bandwidth usage that is equal to or greater than the minimum bandwidth usage may foster high transmit power, high throughput communications when communicating some high-complexity, high transmit power waveforms, which may increase throughput and/or data rates but may incur high energy costs at sidelink receivers and sidelink transmitters, consuming energy that is already limited for sidelink devices, including primary UEs and companion devices and potentially at odds with the PSD constraint.

Furthermore, in a conventional implementation of sidelink communications (e.g., over a UWB channel), there may be channel encoding on the transmitter side and decoding on the receiver side. The encoding may use a modulator on the transmitter side, and the decoding may use a demodulator on the receiver side. While the encoding and decoding may provide coding protection, the encoding and the decoding involve a higher complexity, a higher power consumption, and an increased latency.

Various aspects relate generally to capitalizing on the spectral bandwidth of UWB, FR2, and/or FR2 communications (e.g., to increase throughput and/or data rates), while decreasing a total transmit power by implementing a waveform for communications that is associated with low complexity and may be relatively short in the time domain through sidelink frequency domain data set repetition (e.g., to mitigate high energy costs). Some aspects more specifically relate to a primary UE generating and transmitting, and a companion device (relay UE) receiving, a plurality of repetitions of a data set intended for a network entity via UWB, FR2, and/or FR3 communications. Some aspects more specifically relate to a UE that transmits a first portion of data to a network entity on an access link (Uu link), and transmits precoding information and a second portion of the data (as repetitions) to the companion device. The UE may generate a transmission waveform for sidelink from the frequency domain (FD) signal/tones as part of access link processing. The sidelink is expected to have a greater quantity of resources than the access link. The UE may perform repetition of the FD tones and assign all of the FD tones to the sidelink input buffer. In some aspects, the UE may perform pre-equalization to modify the signal such that the signals arrive at the receiver as if there is no over-the-air (OTA) channel. The UE may map the FD tones to multiple layers. The UE may apply a pseudorandom scrambling sequence on the tones of the different repetitions. The UE may transmit the repetitions.

The companion device may receive the repetitions, remove the scrambling, combine the repetitions to obtain the second portion, and forward the second portion to the network entity. The companion device may forward the second portion as equalized tones (that result from the combination) to the network entity directly over the access link. The companion device may use the precoding information to transmit the second portion. The network entity may receive and combine the first portion and the second portion to obtain the data.

Particular aspects of the subject matter described in this disclosure can be implemented to realize one or more of the following potential advantages. By transmitting precoding information with the second portion, and the companion device using the precoding information to receive repetitions carrying the second portion and forward the second portion, the companion device may help increase the robustness of an uplink transmission while maintaining a lower complexity at the UE and the companion device, because no sidelink encoder and decoder are used. As a result, the UE and the companion device conserve power and processing resources while increasing throughput and reducing latency due to the robustness and multiple signals. The UE's sidelink repetitions may provide for high flexibility to address different scenarios of allocation size and UWB regulatory requirements in an efficient way (e.g., minimal bandwidth requirements). The robustness may further provide better coverage (e.g., for a cell edge) due to antenna diversity (the UE antennas and the companion device antennas are un-correlated) and provide for a higher overall total radiated power (TRP) of the UE and the companion device with respect to the UE, for the same number of transmit antennas. Also, by using pre-equalization, there is no need for minimum mean-squared error (MMSE) equalization, and the complexity at the companion device is reduced.

The power consumption of the primary UE and/or the companion device may be reduced by avoiding relatively high transmit powers that are otherwise needed to support the successful communication of a single signal repetition. In some examples, the described techniques can be used to augment data reception from the network node by sharing local received samples between sidelink devices via licensed (e.g., FR2/FR3) and/or unlicensed (e.g., UWB) high throughput sidelink technologies. By generating and transmitting a plurality of repetitions of the data set, the companion device may augment an antenna rank of the primary UE without incurring additional manufacturing costs. Thus, antenna augmentation may enhance data throughput (e.g., via antenna rank augmentation), increase coverage, and improve the effects of interference.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

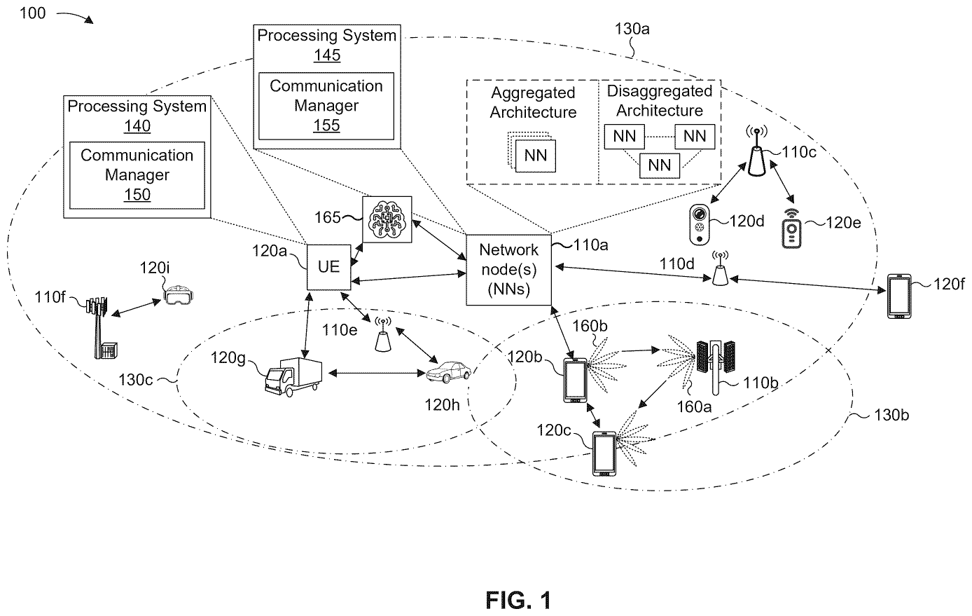

FIG. 1 is a diagram illustrating an example of a wireless communication network 100. The wireless communication network 100 may be or may include elements of a 5G network or a 6G network, among other examples. The wireless communication network 100 may include multiple network nodes 110 (shown as “NN” in example 100). For example, in FIG. 1, the wireless communication network 100 includes a network node 110a, a network node 110b, network node 110c, network node 110d, network node 110e, and a network node 110f. The network nodes 110 may support communications with multiple UEs 120. For example, in FIG. 1, the network nodes 110 support communication with a UE 120a, a UE 120b, a UE 120c, a UE 120d, a UE 120e, a UE 120f, a UE 120g, a UE 120h, and a UE 120i (each of which also may be referred to herein simply as a “UE 120”). In some examples, a UE 120 may also communicate with other UEs 120 and a network node 110 may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHZ), FR2 (24.25 GHz through 52.6 GHz), FR3 (7.125 GHz through 24.25 GHZ), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point, a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single transmit receive point that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle OTA communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IOT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a transmit receive point, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-transmit receive point (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, a UE (e.g., a UE 120) may include a communication manager 150. As described in more detail elsewhere herein, the communication manager 150 may transmit, to a network entity via an access link, a first set of signals associated with a data set; and transmit, to a wireless device via a sidelink, precoding information and a second set of signals that includes a plurality of repetitions associated with the data set. Additionally, or alternatively, the communication manager 150 may perform one or more other operations described herein.

In some aspects, a wireless device (e.g., UE 120) may include a communication manager 150. As described in more detail elsewhere herein, the communication manager 150 may receive precoding information; receive, from a UE via a sidelink, a set of signals that includes a plurality of repetitions of a data set; and forward the set of signals to a network entity using the precoding information. Additionally, or alternatively, the communication manager 150 may perform one or more other operations described herein.

In some aspects, a network entity (e.g., a network node 110) may include a communication manager 155. As described in more detail elsewhere herein, the communication manager 155 may receive, from a UE via an access link, a first set of signals associated with a data set; receive, from a wireless device via a sidelink, a second set of signals that include a plurality of repetitions associated with the data set; and perform combined demodulation, based at least in part on precoding information, of the first set of signals and the second set of signals to generate the data set. Additionally, or alternatively, the communication manager 155 may perform one or more other operations described herein.

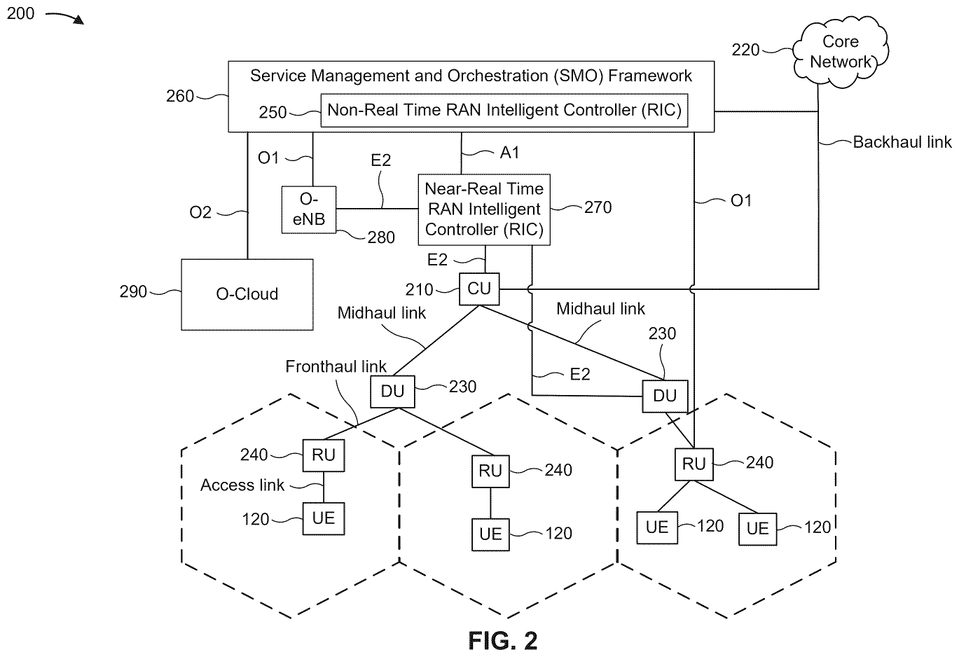

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

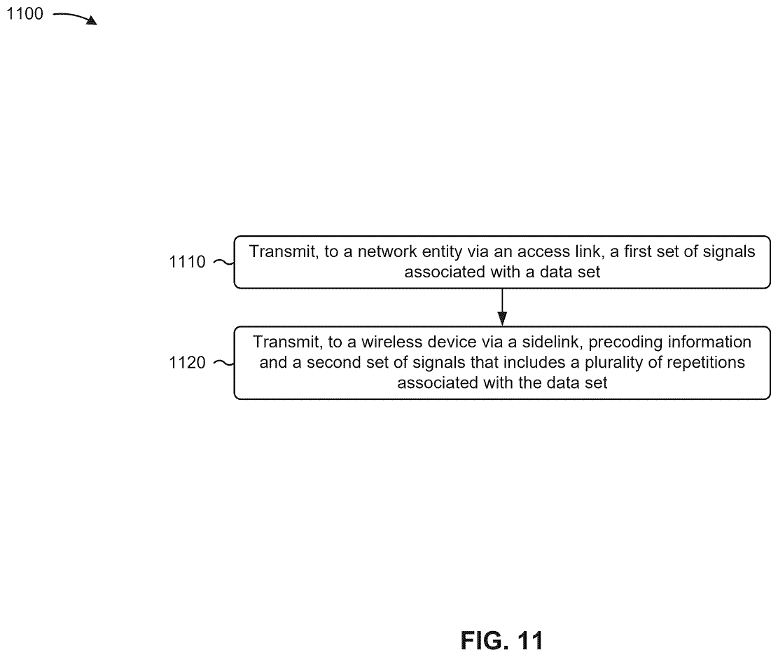

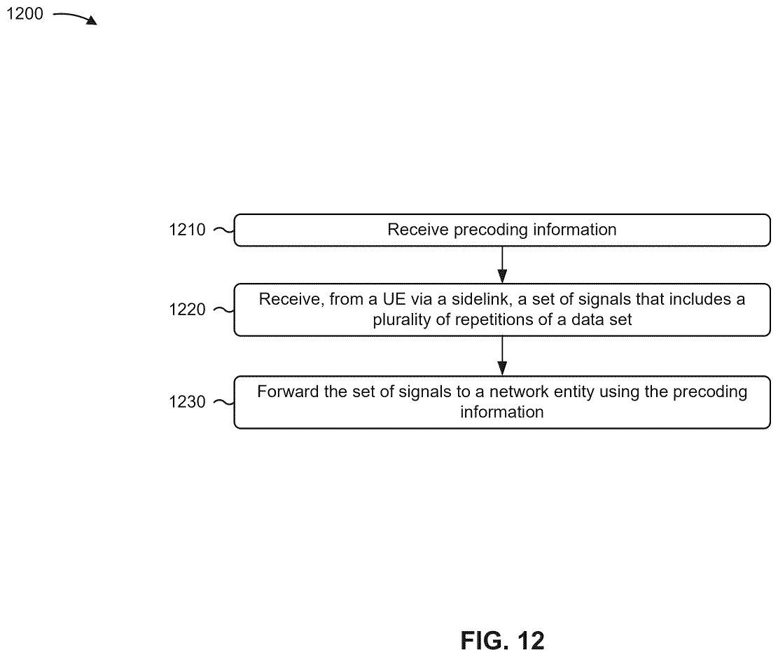

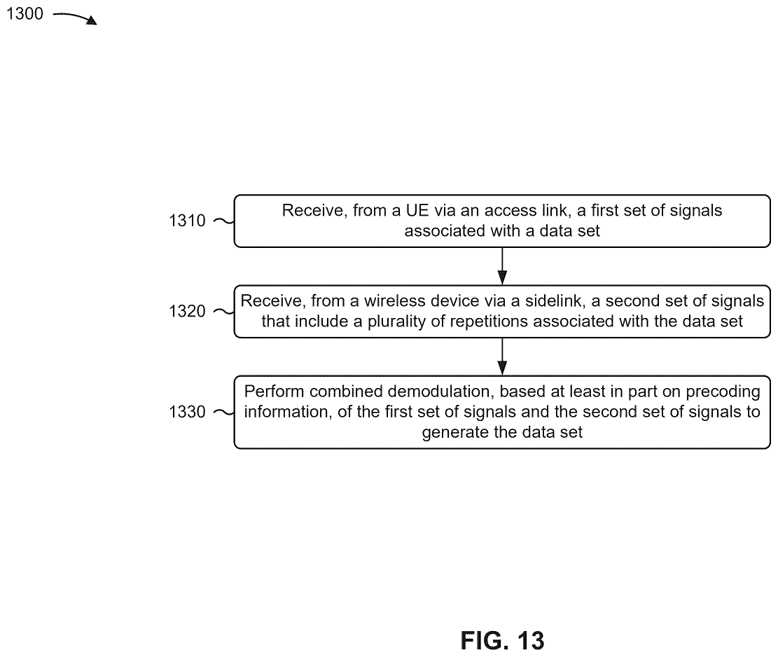

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with reduced complexity signals for uplink, as described in more detail elsewhere herein. For example, the processing system 145 of the network node 110, the processing system 140 of the UE 120, the CU 210, the DU 230, or the RU 240 may perform or direct operations of, for example, process 1100 of FIG. 11, process 1200 of FIG. 12, process 1300 of FIG. 13, or other processes as described herein (alone or in conjunction with one or more other processors). In some aspects, the wireless device described herein is the UE 120, is included in the UE 120, or includes one or more components of the UE 120 shown in FIG. 1. Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 1100 of FIG. 11, process 1200 of FIG. 12, process 1300 of FIG. 13, or other processes as described herein. In some examples, executing instructions may include running the instructions, converting the instructions, compiling the instructions, or interpreting the instructions, among other examples.

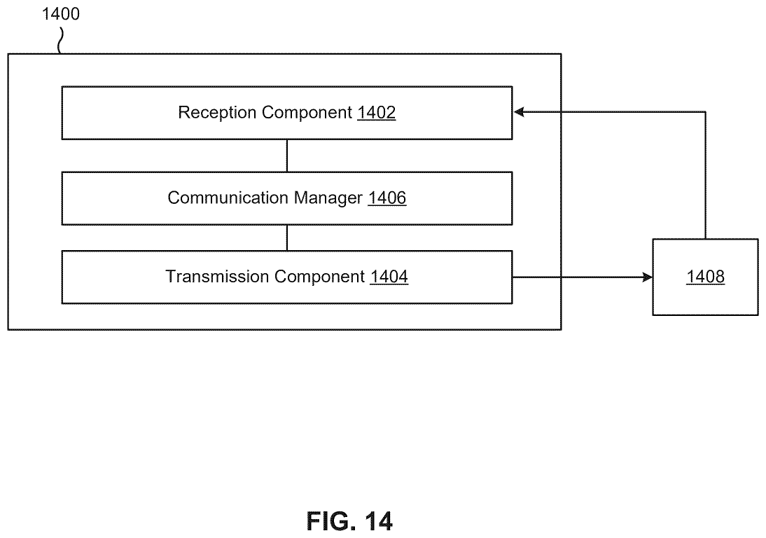

In some aspects, a UE (e.g., a UE 120) includes means for transmitting, to a network entity via an access link, a first set of signals associated with a data set; and/or means for transmitting, to a wireless device via a sidelink, precoding information and a second set of signals that includes a plurality of repetitions associated with the data set. The means for the UE to perform operations described herein may include, for example, one or more of communication manager 150, processing system 140, a radio, one or more RF chains, one or more transceivers, one or more antennas, one or more modems, a reception component (for example, reception component 1402 depicted and described in connection with FIG. 14), or a transmission component (for example, transmission component 1404 depicted and described in connection with FIG. 14), among other examples.

In some aspects, a wireless device (e.g., a companion device, a UE 120) includes means for receiving precoding information; means for receiving, from a UE via a sidelink, a set of signals that includes a plurality of repetitions of a data set; and/or means for forwarding the set of signals to a network entity using the precoding information. In some aspects, the means for the wireless device to perform operations described herein may include, for example, one or more of communication manager 150, processing system 140, a radio, one or more RF chains, one or more transceivers, one or more antennas, one or more modems, a reception component (for example, reception component 1402 depicted and described in connection with FIG. 14), or a transmission component (for example, transmission component 1404 depicted and described in connection with FIG. 14), among other examples.

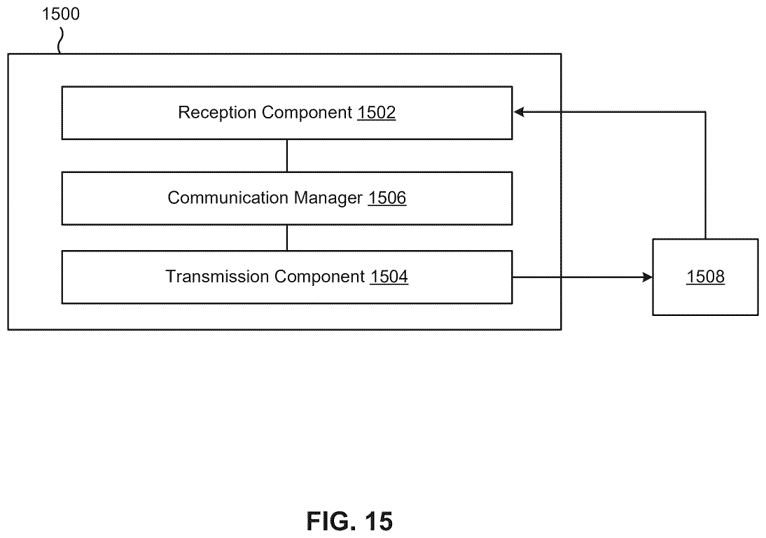

In some aspects, a network entity (e.g., a network node 110) includes means for receiving, from a UE via an access link, a first set of signals associated with a data set; means for receiving, from a wireless device via a sidelink, a second set of signals that include a plurality of repetitions associated with the data set; and/or means for perform combined demodulation, based at least in part on precoding information, of the first set of signals and the second set of signals to generate the data set. In some aspects, the means for the network entity to perform operations described herein may include, for example, one or more of communication manager 150, processing system 140, a radio, one or more RF chains, one or more transceivers, one or more antennas, one or more modems, a reception component (for example, reception component 1502 depicted and described in connection with FIG. 15), or a transmission component (for example, transmission component 1504 depicted and described in connection with FIG. 15), among other examples.

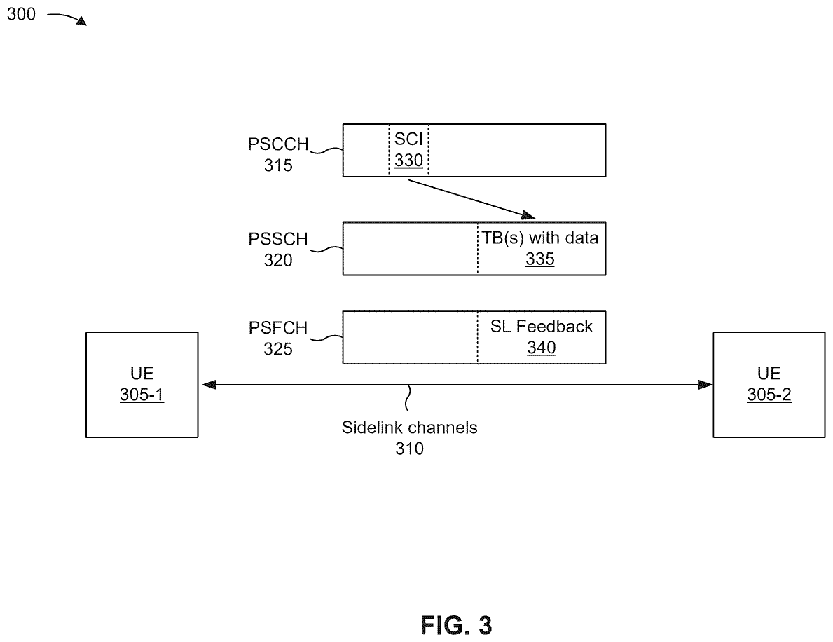

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include vehicle-to-vehicle (V2V) communications, vehicle-to-infrastructure (V2I) communications, and/or vehicle-to-pedestrian (V2P) communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a PSCCH 315, a PSSCH 320, and/or a PSFCH 325. The PSCCH 315 may be used to communicate control information, similar to a PDCCH and/or a PUCCH used for cellular communications with a network node 110 via an access link or an access channel. The PSSCH 320 may be used to communicate data, similar to a PDSCH and/or a PUSCH used for cellular communications with a network node 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QoS) priority value, a resource reservation period, a PSSCH DMRS pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 320, such as a hybrid automatic repeat request (HARQ) process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a sidelink transmission mode (e.g., Mode 1) where resource selection and/or scheduling is performed by a network node 110 (e.g., a base station, a CU, or a DU). For example, the UE 305 may receive a grant (e.g., in downlink control information (DCI) or in a radio resource control (RRC) message, such as for configured grants) from the network node 110 (e.g., directly or via one or more network nodes) for sidelink channel access and/or scheduling. In some aspects, a UE 305 may operate using a transmission mode (e.g., Mode 2) where resource selection and/or scheduling is performed by the UE 305 (e.g., rather than a network node 110). In some aspects, the UE 305 may perform resource selection and/or scheduling by sensing channel availability for transmissions. For example, the UE 305 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy ratio (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or a modulation and coding scheme (MCS) to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

In some examples, sidelink communications may be performed via UWB, FR2, and/or FR3 frequency bands. According to UWB regulations, a minimum bandwidth usage for a sidelink transmission is 500 MHz. UWB regulations may specify a power spectral density constraint of a sidelink transmission. In some examples, an overall allowed transmission power may increase linearly with the used bandwidth and still satisfy the power spectral density constraint. However, because the power spectral density constraint associated with UWB may be relatively low, even when the transmission power is distributed over the minimum bandwidth, a total transmit power may remain capped (e.g., capped at a relatively low level) due to the power spectral density constraint.

The minimum bandwidth usage may foster high transmit power, high throughput communications for some waveforms, which may increase throughput and/or data rates but may incur high energy costs at the UE 305-1 and/or the UE 305-2, consuming energy that may already be limited at sidelink devices and potentially at odds with the power spectral density constraint. Thus, sidelink communications (e.g., UWB sidelink communications) may suffer from high power consumption potential and complexity constraints (e.g., due to inherent characteristics of companion devices such as wearable UEs). Thus, it may be beneficial to decrease a total transmit power by implementing a waveform for communications that is associated with low complexity and may be relatively short in the time domain through sidelink frequency domain data set repetition to take advantage of increased channel capacity while satisfying minimum bandwidth and/or PSD constraints.

In some examples, sidelink communications may be performed via licensed bands (e.g., FR2 and/or FR3) and may have similar parameters and regulation as other sidelink communication schemes, such as CV2X. However, licensed sidelink communications may support many small networks (e.g., one per user), each including a small number of devices (2-4 devices, such as one or more UEs, smart XR glasses, smart watches, etc.). However, one small network may interfere with another nearby small network.

As indicated above, FIG. 3 is provided as an example. Other examples may differ from what is described with respect to FIG. 3.

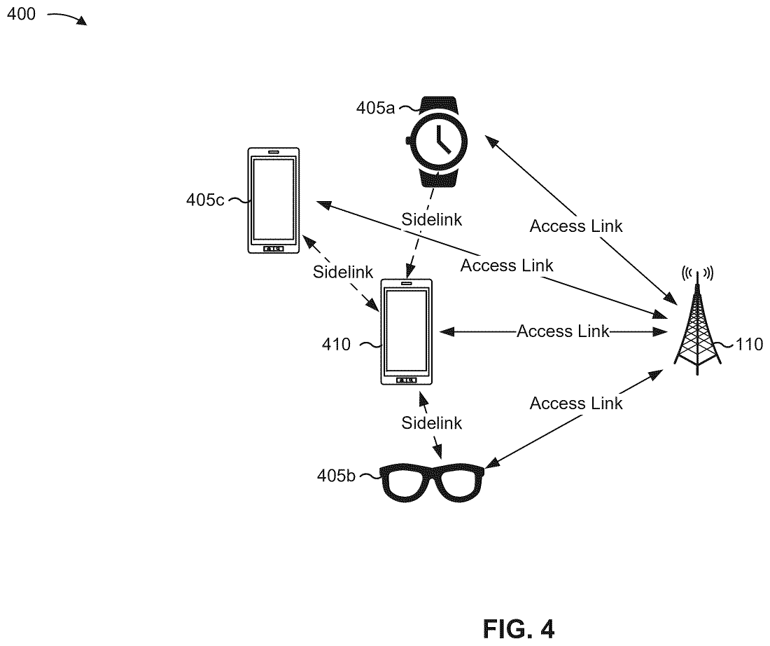

FIG. 4 is a diagram illustrating an example 400 of sidelink communications and access link communications, in accordance with the present disclosure. As wireless communication applications and use cases expand, some users of a primary UE 410 may carry and/or use several wearable devices, such as companion devices 405 that communicate directly with a network node 110 in addition to the primary UE 410.

As shown in FIG. 4, primary UE 410, and companion devices 405, including smart watch 405a, smart glasses 405b, and/or auxiliary UE 405c may communicate with one another via a sidelink, as described above in connection with FIG. 3. The companion devices 405 and the primary UE 410, may in some examples, be part of a “small” licensed band network as also described in connection with FIG. 3. As further shown, in some sidelink modes, the network node 110 may communicate with the primary UE 410 (e.g., directly or via one or more network nodes), such as via a first access link. The primary UE 410 may correspond to one or more UEs described elsewhere herein, such as the UE 120 of FIG. 1. The companion devices 405 may correspond to one or more companion devices described elsewhere herein, and may be an example of a UE 120. For example, the UE 405c may include a UE (e.g., such as UE 120 described in connection with FIG. 1), such as a wearable UE, a companion UE, and/or an auxiliary UE that augments one of more functions of the primary UE 410. A direct link between the primary UE 410 and/or a companion device 405 (e.g., via a PC5 interface) may be referred to as a sidelink, and a direct link between a network node 110 and the primary UE 410 and/or a companion device 405 (e.g., via a Uu interface) may be referred to as an access link. Sidelink communications may be transmitted via the sidelink, and access link communications may be transmitted via the access link. An access link communication may be either a downlink communication (from a network node 110 to the primary UE 410 and/or a companion device 405) and/or an uplink communication (from the primary UE 410 and/or a companion device 405 to a network node 110). An uplink link may have a lower link budget than a downlink link and thus the uplink access link may be used to increase robustness. Sidelink communications may be based on UWB and may be used for short range links.

In some examples, companion devices may be used to augment communications performed via access link between the network node 110 and a primary UE 410, by communicating receiver antenna samples to the primary UE 410. For example, multiple devices (e.g., UEs 405, smart watches 405a, XR glasses 405b, among other examples) may receive data from the network node 110 and share local receive samples with each other via licensed (e.g., FR2 and/or FR3) and/or unlicensed (e.g., UWB) high-throughput sidelink. Antenna augmentation may improve throughput (via increased rank), may improve coverage, and may decrease the effects of interference by increasing robustness through repetition.

There are some expectations for using sidelink over access links. For example, there is to be sufficient bit rate support to assist in antenna sharing, low latency and fast access to the channel, and access link transmissions that meet requirements for the waveform and the target error vector magnitude (EVM), OTA timing accuracy, low complexity, and low power consumption. Characteristics of using sidelink over UWB may include a minimal used bandwidth of 500 MHz and a limited power spectral density.

As indicated above, FIG. 4 is provided as an example. Other examples may differ from what is described with respect to FIG. 4.

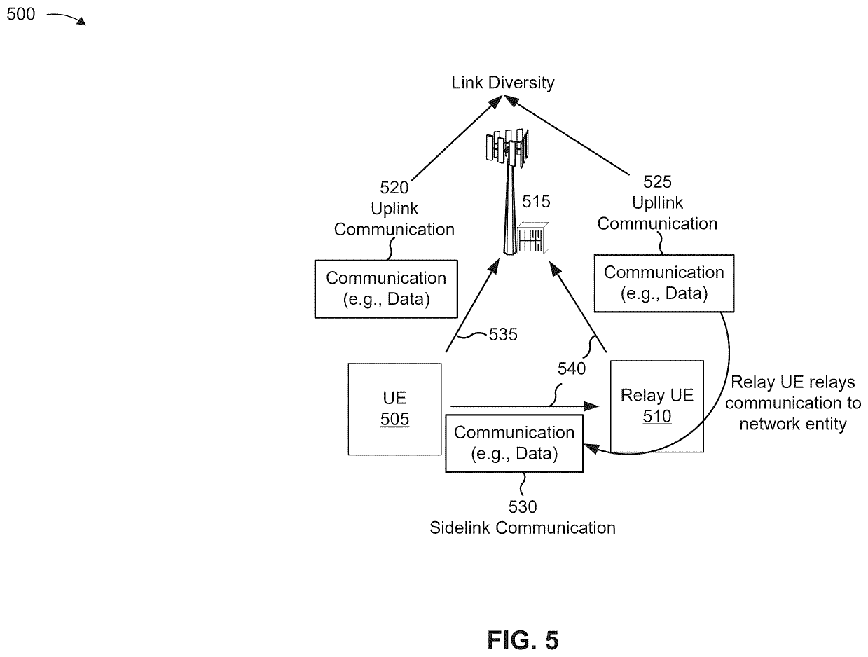

FIG. 5 is a diagram illustrating an example 500 of a relay UE that relays communications between a UE and a network node, in accordance with the present disclosure. As shown, example 500 includes a UE 505, a relay UE 510, and a network entity 515 (e.g., network node 110). In example 500, the UE 505 is a primary UE, and the relay UE 510 is a companion device. In some scenarios, the UE 505 is one UE 120, and the relay UE 510 is another UE 120. In some scenarios, the UE 505 may be referred to as a remote UE.

In a conventional implementation of sidelink communications (e.g., over a UWB channel), there may be channel encoding on the transmitter side and decoding on the receiver side. The encoding may use a modulator on the transmitter side, and the decoding may use a demodulator on the receiver side. While the encoding and decoding may provide coding protection, the encoding and the decoding involve a higher complexity, a higher power consumption, and an increased latency.

According to some aspects described herein, a UE may transmit a first portion of data to a network entity on an access link and transmit precoding information (e.g., PMI and sub-matrix indices) and a second portion of the data (as repetitions) to a companion device. The UE may generate FD tones in preparation for transmission of the first portion on the access link. The sidelink is expected to have a greater quantity of resources than the access link, and thus the UE may perform repetition of the FD tones on the sidelink. This may include assigning all of the FD tones to the sidelink IFFT input buffer. A large bandwidth may be available to transmit multiple repetitions of the same data using multiple MIMO layers (e.g., multiple transmit ports transmit a linear combination of the multiple MIMO layers). Accordingly, the UE may map the FD tones to all of the MIMO layers. The UE may apply a pseudorandom scrambling sequence on the tones of the different repetitions. Different MIMO layers may have different scrambling sequences. The UE may transmit the repetitions to the companion device.

The companion device may receive the repetitions, remove the scrambling, and combine the repetitions to obtain the second portion. The companion device may forward the second portion to the network entity. For example, the companion device may forward the second portion as equalized tones (that result from the combination) directly over the access link. The companion device may use the precoding information to transmit the second portion to the network entity. The network entity may receive and combine the first portion and the second portion to obtain the data.

In some aspects, the UE may perform pre-equalization to modify the signal such that the signals arrive at the receiver as if there is no OTA channel. If pre-equalization is used, the companion device may perform simple averaging. If pre-equalization is not used, the UE may use MMSE equalization.

By transmitting precoding information with the second portion, and the companion device using the precoding information to receive and forward the second portion, the companion device may help increase the robustness of an uplink transmission while maintaining a lower complexity at the UE and the companion device, because no sidelink encoder and decoder are used. As a result, the UE and the companion device conserve power and processing resources while increasing throughput and reducing latency due to the robustness and multiple signals. The UE's sidelink repetitions may provide for high flexibility to address different scenarios of allocation size and UWB regulatory requirements in an efficient way (e.g., minimal bandwidth requirements). The robustness may further provide better coverage (e.g., for a cell edge) due to antenna diversity (the UE antennas and the companion device antennas are un-correlated) and provide for a higher overall total radiated power (TRP) of the UE and the companion device with respect to the UE, for the same number of transmit antennas. Also, by using pre-equalization, there is no need for MMSE equalization and the complexity at the companion device is reduced. A goal of Tx pre-equalization or Tx equalization is to apply a channel inverse on the Tx waveform, such that the result at the receiver is an overall channel response that is equal to or close to unity. In this case, the receiver does not need to perform demodulation (use a channel decoder), which lowers complexity. In some aspects, Tx equalization may be implemented in the framework of an access link. That is, for Tx equalization, the UE may be expected to have information about the access channel. This may include complete information about the access channel, different from 3GPP-compliant precoding that requires only partial channel information, which is reflected in the precoding information.

In some aspects, the UE may transmit a UE capability report (e.g., unsolicited) to the network entity to support dynamic antenna augmentation. The UE may perform precoding for the main UE transmit port and also for the companion device. The UE may transmit precoded data or raw data to the companion device. The companion device may combine the repetitions and apply precoding for transmission of the data to the network entity.

As shown in FIG. 5, the UE 505 may transmit a communication (e.g., data and/or control information) directly to the network entity 515 as an uplink communication 520. Additionally, the UE 505 may transmit a communication (e.g., data and/or control information) indirectly to the network entity 515 via the relay UE 510. For example, the UE 505 may transmit the communication to the relay UE 510 as a sidelink communication, and the relay UE 510 may relay (e.g., forward or transmit) the communication to the network entity 515.

In some aspects, the UE 505 may communicate directly with the network entity 515 via a direct link 535. For example, the uplink communication 520 may be transmitted via the direct link 535. A communication transmitted via the direct link 535 between the UE 505 and the network entity 515 (e.g., in the uplink communication 520) does not pass through and is not relayed by the relay UE 510. In some aspects, the UE 505 may communicate indirectly with the network entity 515 via an indirect link 540. For example, the uplink communication 525 and the sidelink communication 530 may be transmitted via different segments of the indirect link 540. A communication transmitted via the indirect link 540 between the UE 505 and the network entity 515 (e.g., in the uplink communication 525 and the sidelink communication 530) passes through and is relayed by the relay UE 510. Using the communication scheme shown in FIG. 5 may improve network performance and increase reliability by providing the UE 505 with link diversity for communicating with the network entity 515.

In some examples, the UE 505 may transmit a communication (e.g., the same communication) to the network entity 515 via both the direct link 535 and the indirect link 540. In some examples, the indirect link may be an example of a licensed sidelink (e.g., FR2, and/or FR3) and/or an unlicensed sidelink (e.g., UWB sidelink). The UE 505 transmitting the communication to the network entity 515 via the direct link 535 and via the indirect link 540 may benefit from antenna augmentation. For example, the UE 505 may include a set of N antennas, and the UE 510 may include a set of M antennas, where N>M. The network entity 515 receiving a communication (e.g., the same communication) from the UE 505 via both the direct link 535 and the indirect link 540 may experience a signal having an increased power, as if the UE 505 has more than N antennas, in comparison to receiving the communication from only the UE 505.

As indicated above, FIG. 5 is provided as an example. Other examples may differ from what is described with respect to FIG. 5.

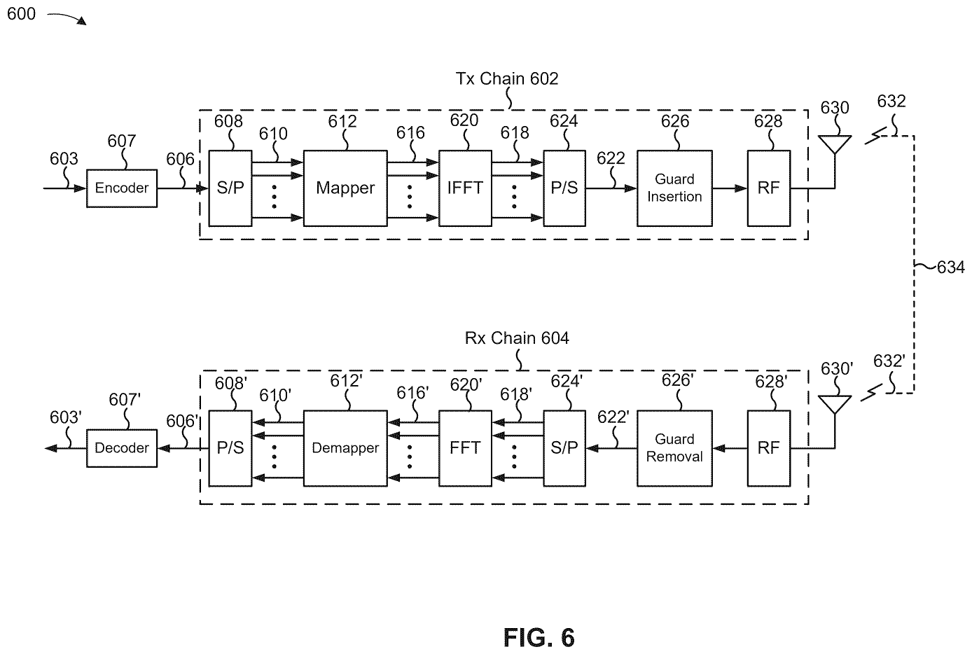

FIG. 6 is a diagram illustrating an example 600 of a transmit (Tx) chain 602 and a receive (Rx) chain 604 of a UE 120, in accordance with the present disclosure. In some aspects, one or more components of Tx chain 602 may be implemented in processing system 140 or processing system 145, as described above in connection with FIG. 1. In some aspects, Tx chain 602 may be implemented in the UE 120 for transmitting data 606 (e.g., uplink data, an uplink reference signal, and/or uplink control information) to a network entity (e.g., network node 110) on an uplink channel.

An encoder 607 may alter a signal (e.g., a bitstream) 603 into data 606. Data 606 to be transmitted is provided from encoder 607 as input to a serial-to-parallel (S/P) converter 608. In some aspects, S/P converter 608 may split the transmission data into N parallel data streams 610.

The N parallel data streams 610 may then be provided as input to a mapper 612. Mapper 612 may map the N parallel data streams 610 onto N constellation points. The mapping may be done using a modulation constellation, such as binary phase-shift keying (BPSK), quadrature phase-shift keying (QPSK), 8 phase-shift keying (8PSK), quadrature amplitude modulation (QAM), etc. Thus, mapper 612 may output N parallel symbol streams 616, each symbol stream 616 corresponding to one of N orthogonal subcarriers of an inverse fast Fourier transform (IFFT) component 620. These N parallel symbol streams 616 are represented in the frequency domain and may be converted into N parallel time domain sample streams 618 by IFFT component 620.

In some aspects, N parallel modulations in the frequency domain correspond to N modulation symbols in the frequency domain, which are equal to N mapping and N-point IFFT in the frequency domain, which are equal to one (useful) OFDM symbol in the time domain, which are equal to N samples in the time domain. One OFDM symbol in the time domain, Nₛ, is equal to N_{cp} (the number of guard samples per OFDM symbol)+N (the number of useful samples per OFDM symbol).

The N parallel time domain sample streams 618 may be converted into an OFDM/OFDMA symbol stream 622 by a parallel-to-serial (P/S) converter 624. A guard insertion component 626 may insert a guard interval between successive OFDM/OFDMA symbols in the OFDM/OFDMA symbol stream 622. The output of guard insertion component 626 may then be upconverted to a desired transmit frequency band by a radio frequency (RF) front end 628. An antenna 630 may then transmit the resulting signal 632.

In some aspects, Rx chain 604 may utilize OFDM/OFDMA. In some aspects, one or more components of Rx chain 604 may be implemented in processing system 140 or processing system 145, as described above in connection with FIG. 1. In some aspects, Rx chain 604 may be implemented in UE 120 for receiving data 606 (e.g., downlink data, a downlink reference signal, and/or downlink control information) from a network node 110 on a downlink channel.

A transmitted signal 632 is shown traveling over a wireless channel 634 from Tx chain 602 to Rx chain 604. When a signal 632′ is received by an antenna 630′, the received signal 632′ may be downconverted to a baseband signal by an RF front end 628′. A guard removal component 626′ may then remove the guard interval that was inserted between OFDM/OFDMA symbols by guard insertion component 626.

The output of guard removal component 626′ may be provided to an S/P converter 624′. The output may include an OFDM/OFDMA symbol stream 622′, and S/P converter 624′ may divide the OFDM/OFDMA symbol stream 622′ into N parallel time-domain symbol streams 618′, each of which corresponds to one of the N orthogonal subcarriers. A fast Fourier transform (FFT) component 620′ may convert the N parallel time-domain symbol streams 618′ into the frequency domain and output N parallel frequency-domain symbol streams 616′.

A demapper 612′ may perform the inverse of the symbol mapping operation that was performed by mapper 612, thereby outputting N parallel data streams 610′. A P/S converter 608′ may combine the N parallel data streams 610′ into a single data stream 606′. Ideally, data stream 606′ corresponds to data 606 that was provided as input to Tx chain 602. Data stream 606′ may be decoded into a decoded data stream 603′ by decoder 607′.

In some examples, aspects of the Tx chain 602 may be implemented by a companion device (e.g., such as companion device 405 described in connection with FIG. 4 and/or relay UE 510 described in connection with FIG. 5) for communicating with a primary UE 410 (e.g., such as primary UE 410 described in connection with FIG. 4 and/or UE 505 described in connection with FIG. 5) and/or by the primary UE to communicate with a network node. Additionally or alternatively, aspects of the Rx chain 604 may be implemented by a primary UE to receive receiver antenna samples from the companion device and/or by the companion device to communicate with the network node.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of components (e.g., one or more components) shown in FIG. 6 may perform one or more functions described as being performed by another set of components shown in FIG. 6.

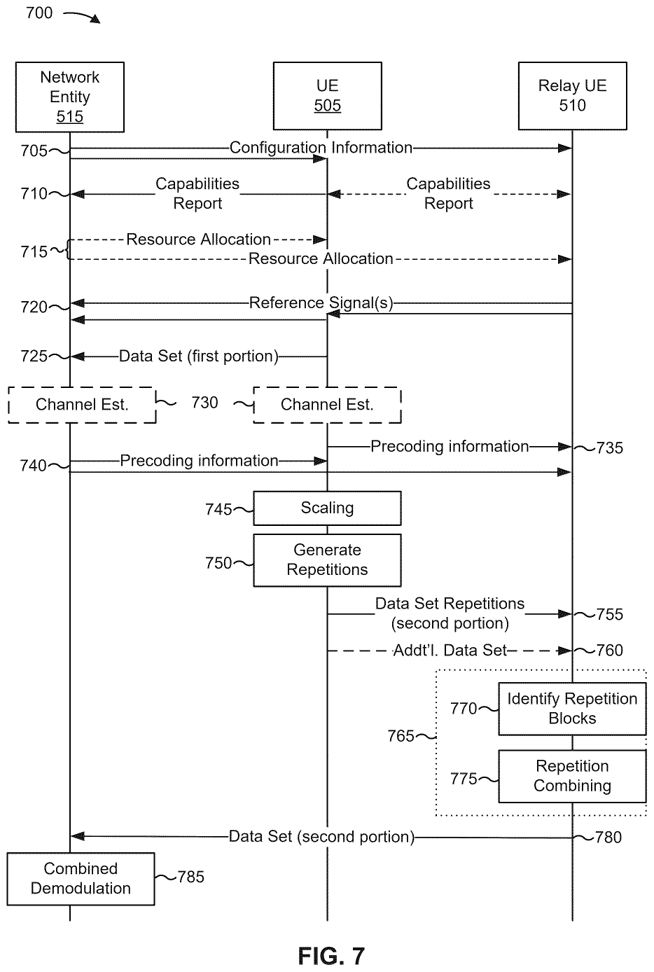

FIG. 7 is a diagram of an example 700 associated with uplink antenna augmentation using sidelink and companion devices, in accordance with the present disclosure. In some aspects, the relay UE 510 may be a transmitter wireless device, such as an auxiliary UE, a wearable UE, a reduced-complexity UE, and/or a companion device, as described herein. In some aspects, the network entity 515, the UE 505, and the relay UE 510 may be part of a wireless communication network (e.g., wireless communication network 100). The network entity 515, the UE 505, and the relay UE 510 may have established a wireless connection prior to operations shown in FIG. 7.

As shown by reference number 705, the network entity 515 may transmit, and the UE 505 may receive, configuration information. In some aspects, the UE 505 may receive the configuration information via one or more of system information (e.g., a master information block (MIB) and/or a system information block (SIB), among other examples), RRC signaling, one or more MAC-CEs, and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (e.g., an indication described herein) may include a dynamic indication, such as one or more MAC-CEs and/or one or more DCI messages, among other examples.

In some aspects, the configuration information may indicate that the UE 505 is to perform combined modulation on a data set transmitted to the network entity 515 and the relay UE 510. In some aspects, the configuration information may indicate a resource allocation over which the UE 505 and/or the relay UE is to communicate via UWB, FR2, and/or FR3 frequency bands.

The UE 505 may configure itself based at least in part on the configuration information. In some aspects, the UE 505 may be configured to perform one or more operations described herein based at least in part on the configuration information.

As shown by reference number 710, the UE 505 and/or the relay UE 510 may transmit, and the network entity 515, the UE 505, and/or the relay UE 510 may receive, a capabilities report. The capabilities report may indicate whether the UE 505 and/or the relay UE 510 supports a feature and/or one or more parameters related to the feature. For example, the capability information may indicate a capability and/or parameter for generating data set repetitions, transmitting sidelink reference signals, performing data processing on a combined data set, among other examples. As another example, the capabilities report may indicate a capability and/or parameter for licensed (e.g., FR2 and/or FR2) and/or unlicensed (e.g., UWB) sidelink communications. One or more operations described herein may be based on capability information of the capabilities report. For example, the UE 505 and/or the relay UE 510 may perform a communication in accordance with the capability information, or may receive configuration information that is in accordance with the capability information.

In some scenarios, a UE capability request and a UE capability report occur during a UE attach process. It is possible that during the attach process, a user does not have a companion device (e.g., smart watch). However, in a later time, the UE is to perform a transmission over the access link. In this case, the UE 505 may transmit a UE capability report in an unsolicited way (without a UE capabilities enquiry by the network entity 515) to indicate changes related to the UE 505 and the relay UE 510 pairing or unpairing. The option for full capability information may be added to a new capability section related to the access link or added to an update of existing parameters (e.g., quantity of transmit ports, quantity of transmit antenna panels).

In some aspects, the configuration information described in connection with reference number 705 and/or the capabilities report(s) described in connection with reference number 710 may include information transmitted via multiple communications. Additionally, or alternatively, the network entity 515 may transmit the configuration information, or a communication including at least a portion of the configuration information, before and/or after the UE 505 and/or the relay UE 510 transmits the capabilities report. For example, the network entity 515 may transmit a first portion of the configuration information before the capabilities report, the UE 505 and/or the relay UE 510 may transmit at least a portion of the capabilities report, and the network entity 515 may transmit a second portion of the configuration information after receiving the capabilities report.

As shown by reference number 715, the network entity 515 may transmit, and the UE 505 and/or the relay UE 510 may receive, a resource allocation. For example, the network entity 515 may transmit, and the UE 505 and/or the relay UE 510 may receive, a resource allocation for communications between wireless communication devices within a distance threshold. In some aspects, the distance threshold may include a size of a user specific network for communications over FR2 and/or FR3 sidelink. For example, a distance between the UE 505 and the relay UE 510 may be within the distance threshold. As a result, the UE 505 and the relay UE 510 may both correspond to a same user and/or may be allocated a same resource pool. In some aspects, the resource allocation may correspond to a user-specific network (e.g., a “small” network). In some aspects, the UE 505 may receive the resource allocation from the network entity 515 and may transmit an indication of the resource allocation to the relay UE 510.

In some aspects, a first resource pool that is associated with wireless communication devices within the distance threshold at least partially overlaps with a second resource pool that is associated with wireless communication devices within a second distance threshold that satisfies a resource reuse distance threshold. For example, sidelink over licensed bands (e.g., FR2 and/or FR3) may incorporate allocation of user-specific network resource pools to mitigate interference between relatively close users by allocating user-specific networks that are relatively close (e.g., within the resource reuse distance threshold) different resource pools. Additionally or alternatively, user-specific networks that are relatively separated (e.g., outside the resource reuse distance threshold) may be allocated resource pools that at least partially overlap.

As shown by reference number 720, the UE 505 or the relay UE 510 may transmit (e.g., via an access link), and the network entity 515 may receive, a set of one or more reference signals (e.g., SRS). In some aspects, the one or more reference signals may include one or more DMRSs. SRSs may be multiplexed over multiple frequencies. The relay UE 510 may transmit a set of one or more reference signals via a sidelink to the UE 505.

As shown by reference number 725, the UE 505 may transmit, and the network entity 515 may receive, a data set, or a first portion of the data set. For example, the network entity 515 may receive, from the UE 505 via the access link, a first set of one or more signals including at least one instance of a data set intended for the network entity 515. In some aspects, the at least one instance of a data set and the set of one or more reference signals described in connection with reference number 720 may be communicated in a same transmission and/or message. In some aspects, the at least one instance of a data set and the set of one or more reference signals described in connection with reference number 720 may be communicated via different transmissions and/or messages. In some aspects, the set of one or more reference signals described in connection with reference number 720 may correspond to (e.g., may be associated with decoding) the at least one instance of the data set. In some aspects, the network entity 515 may obtain the data set (e.g., frequency domain raw samples) from the first set of one or more signals using the set of one or more reference signals.

As shown by reference number 730, the network entity 515 or the UE 505 may perform channel estimation. For example, the UE 505 may measure a channel quality (or any other parameter) of the sidelink link between the UE 505 and the network entity 515. The network entity 515 may measure a channel quality (or any other parameter) of the access link between the UE 505 and the network entity 515. A channel may be measured using the one or more access link reference signals (e.g., DMRS) and/or a channel quality indication associated with the one or more access link reference signals (e.g., RSSI via DMRS).

As shown by reference number 735, the UE 505 may transmit precoding information (e.g., transmitted PMI (TPMI), sub-matrix indices) for the access link or the sidelink to the relay UE 510. In some aspects, as shown by reference number 740, the network entity 515 may transmit precoding information for the access link to the UE 505 and the relay UE 510. The precoding information may be based at least in part on the channel estimation. Precoding information may be used to precode data from the UE 505 to the relay UE 510 or to precode data from the relay UE 510 to the network entity 515 (not precoded from the UE 505 to the relay UE 810).

As shown by reference number 745, the UE 505 may perform scaling. For example, the UE 505 may perform a scaling estimation procedure using a set of one or more respective sidelink reference signals. In some aspects, the scaling estimation procedure may include scaling the data set over a frequency range that satisfies a bandwidth threshold associated with the sidelink between the UE 505 and the relay UE 510. In some aspects, the bandwidth threshold may include a minimum bandwidth associated with licensed (e.g., FR2 and/or FR3) and/or unlicensed (e.g., UWB) sidelink communications.

As shown by reference number 750, the UE 505 may generate a set of repetitions of the data set. The repetitions may be FD tones prepared for the access link from the UE 505 to the network entity 515. The repetitions may be mapped to multiple MIMO layers that are scrambled differently. The UE 505 may generate a plurality of repetitions of the data set in association with scaling the data set (e.g., as described in connection with reference number 745) according to one or more parameters associated with a sidelink between the UE 505 and the relay UE 510. In some aspects, scaling the data set according to the one or more parameters may be associated with performing the scaling estimation procedure described in connection with reference number 745. For example, the UE 505 may perform scaling estimation based on RSSI, RSRP, and/or channel estimation, and/or may apply the estimated scaling, and/or may apply scaling to meet one or more UWB regulations. In some aspects, each repetition may be associated with a respective scrambling sequence (e.g., a user-specific scrambling sequence).

In some aspects, the one or more parameters associated with the sidelink between the UE 505 and the relay UE 510 include a frequency bandwidth threshold (e.g., a minimum bandwidth, as described herein), RSSI, a frequency range of the sidelink (e.g., FR2, FR3, and/or UWB), a PSD threshold, and/or a channel quality indication (e.g., a channel quality parameter derived from the one or more reference signals described in connection with reference number 720, among other examples).

As shown by reference number 755, the UE 505 may transmit, and the relay UE 510 may receive, the set of repetitions of the data set. The set of repetitions may be for a second portion of the data set that will be combined with the first portion transmitted on the access link as shown by reference number 725. For example, the UE 505 may transmit, to the relay UE 510 via the sidelink, a second set of one or more signals including the plurality of repetitions of the data set. In some aspects, the set of one or more sidelink reference signals described in connection with reference number 720 may correspond to (e.g., may be associated with decoding) the plurality of repetitions of the data set.

In some aspects, the second set of one or more signals includes a plurality of frequency domain samples, of the first set of one or more signals (e.g., described in connection with reference number 725), generated by the UE 505. In some aspects, the plurality of frequency domain samples may span a frequency bandwidth that satisfies a bandwidth threshold (e.g., a minimum bandwidth associated with licensed (e.g., FR2 and/or FR3) and/or unlicensed (e.g., UWB) sidelink communications).

As shown by reference number 760, in some examples, the UE 505 may transmit, and the relay UE 510 may receive, an additional set of repetitions including an additional data set. For example, the UE 505 may transmit a plurality of repetitions of an additional data set multiplexed with the plurality of repetitions of the data set. In some aspects, the additional data set may originate from the UE 505, the network entity 515, and/or a second network entity.

As shown by reference number 765, the UE 505 may perform a data processing procedure. For example, as shown by reference number 770, the data processing procedure may include the relay UE 510 identifying repetition blocks of the set of repetitions of the data set. For example, the relay UE 510 may identify a set of repetition blocks associated with the plurality of repetitions of the data set.

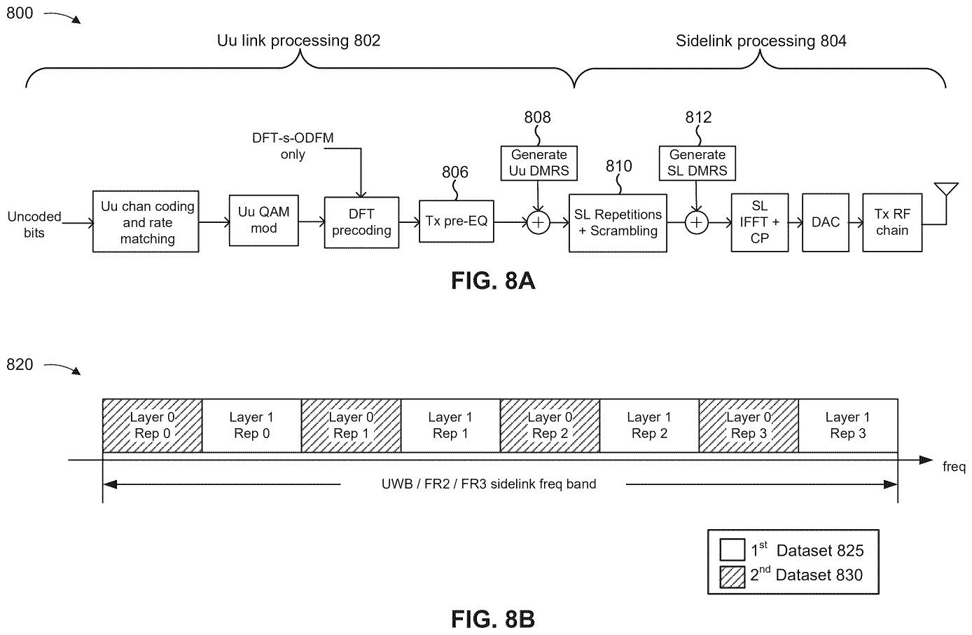

As shown by reference number 775, the data processing procedure may include the relay UE 510 performing repetition combining to obtain a combined data set. In some aspects, the relay UE 510 may combine the plurality of repetitions of the data set into a sidelink data set. The relay UE 510 may receive and combine the plurality of repetitions based at least in part on the precoding information for the sidelink. The relay UE 510 may perform maximum ratio combining (MRC) as described with reference to FIGS. 8A and 8B.

As shown by reference number 780, the relay UE 510 may transmit the data set (second portion of the data set) obtained from the repetitions as a third set of one or more signals. The relay UE 510 may transmit the data set based at least in part on the precoding information for the access link. The relay UE 510 may transmit the data set on an access link.

The network entity 515 may receive the first set of signals (first portion of the data set) from the UE 505 and the third set of signals (second portion of the data set) from the relay UE 510. The network entity 515 may combine the first portion of the data set from the first set of signals and the second portion of the data set from the second set of signals to obtain the whole data set. As shown by reference number 785, the network entity 515 may perform a combined demodulation on the first set of signals and the second set of signals. In some aspects, a quantity of received samples for performing the combined demodulation is associated with a quantity of received samples of the at least one instance of the data set (first portion) and a quantity of received samples of at least one other instance of the data set (second portion). For example, a dimension of the demodulator used for combined demodulation may be:

$$NTx = N\_Tx \_Uu \_PrimaryUE + N\_TX \_Uu \_Companion ,$$

where NTx is a total quantity of received samples, N_Tx_Uu_PrimaryUE is a total quantity of samples transmitted by the UE 510, and N_TX_Uu_Companion is a total quantity of samples transmitted by the relay UE 510. In some aspects, the network entity 515 may combine the first set of signals and the second set of signals using the reference signals from the UE 505 and the relay UE 510. In some aspects, the combined demodulation may be associated with a first input including a first channel estimation and a first estimated quantity of samples from the UE 505 (e.g., described in connection with reference number 730), and/or a second input including a second channel estimation and a second estimated quantity of samples from the relay UE 510 (e.g., described in connection with reference number 730).

As indicated above, FIG. 7 is provided as an example. Other examples may differ from what is described with respect to FIG. 7.

In some aspects, a sidelink scheme for licensed (FR2 and/or FR3) and/or unlicensed (UWB) communications may be used by the UE 505 and the relay UE 510. On the companion device side of the relay UE 510, the sidelink scheme may include the extraction of a user allocation (e.g., user data) extracted from an FFT output (e.g., an FFT output as described in connection with FIG. 6). The user allocation (e.g., including frequency domain raw IQ samples) may be repeated in the frequency domain to create a signal having a bandwidth that satisfies a minimum bandwidth guideline (e.g., regulation). The relay UE 510 may prepare the user allocation for transmission without additional coding (e.g., coding that would otherwise be used to mitigate adverse channel conditions and/or noise), instead relying on the robustness provided by the transmission of multiple repetitions. Scrambling may be added to the repetitions to avoid large peak-to-average power ratios that might be caused by the repetitions. The UE 505 may include single port sidelink DMRS per repetition to allow coherent combining of the repetitions at the relay UE 505. Additionally or alternatively, frequency selective scaling may be performed to meet UWB regulations (e.g., scaling per 1 MHz). For example, the same transmitted signal over sidelink may have a same spectral shape as the Uu channel spectral shape, which may violate PSD constraints without scaling.

The sidelink scheme may include the relay UE 510 combining received repetitions using the sidelink DMRSs. The relay UE 510 may process the repetitions and the received user allocation using sidelink DMRSs from the UE 505. The user-specific scrambling and repetitions combining may serve as an interference mitigation mechanism between neighboring users. Thereby, the described techniques can be used to augment data reception at the relay UE 510 by sharing local received samples between sidelink devices via licensed (e.g., FR2/FR3) and/or unlicensed (e.g., UWB) high throughput sidelink technologies.

FIG. 8A is a diagram illustrating an example 800 associated with sidelink reception/transmission processing, in accordance with the present disclosure. As shown in FIG. 8A, example 800 may include aspects of Rx chain 604 and/or Tx chain 602 described in connection with FIG. 6 and in connection with Uu link processing 802 and sidelink processing 804 by the UE 505. In some aspects, the components described with reference to FIG. 8A may be performed by a companion device (e.g., relay UE 510) as described herein.

The UE 505 may include a set of Uu link Tx chains (e.g., N Tx chains) for access link communications. The UE 505 may transmit a communication, to the network entity 515, that includes a data set. As part of the Uu link processing 802, the UE 505 may perform Uu channel coding and rate matching of uncoded bits for the data set (input). The UE 505 may perform QAM modulation and DFT precoding (e.g., only DFT-s-OFDM). In some aspects, the UE 505 may perform Tx pre-equalization with a Tx pre-equalization (EQ) component 806. Tx pre-equalization may minimize the complexity of the Rx side (relay UE 510). To support the Tx pre-equalization scheme more efficiently, the sidelink (SL) waveform may be multi-layer (e.g., MIMO 2×2).

In some aspects, there are two schemes. In a first scheme, the UE 505 does not perform Tx equalization. This may require a demodulator at the relay UE 510. In a second scheme, the UE 505 may perform Tx equalization. This may not require a demodulator at the relay UE 510—just repetition combining (much lower complexity).

A Uu DMRS generation component 808 may generate a Uu DMRS that is added to the signal. A DMRS may carry information used to estimate a radio channel for demodulation of an associated physical channel (e.g., PDCCH, PDSCH, PBCH, PUCCH, PUSCH, PSSCH, PSCCH). The design and mapping of a DMRS may be specific to a physical channel for which the DMRS is used for estimation. DMRSs are UE-specific, can be beamformed, can be confined in a scheduled resource, can be transmitted on a wideband, and can be transmitted only when necessary. DMRSs may be used for both downlink communications and uplink communications.

As for the sidelink processing 804, a sidelink repetition and scrambling component 810 may perform frequency domain (FD) repetition to generate repetitions of the same data set (same portion of the data set). The sidelink repetition and scrambling component 810 may scramble each repetition differently. The scrambling helps to avoid a peak-to-average-power ratio (PAPR) increase due to the repetition of the same sequence. This may involve complex data scrambling (not just bit scrambling) that is performed by multiplying by a pre-defined pseudo-random sequence (e.g., random {−1,1} patterns per I,Q). The sidelink repetition and scrambling component 810 may perform FD multiplexing if there is more than one data stream.

The sidelink DMRS component 812 may generate and add a sidelink DMRS that allows for low complexity combining of the repetitions. The sidelink DMRS supports efficient combining (e.g., MRC combining) of the repetitions by the relay UE 510. The sidelink processing 804 may also include the UE 505 performing IFFT and cyclic prefix (CP) appending according to a numerology optimized for the sidelink. The UE 505 may perform digital-to-analog conversion (DAC) and prepare for transmission of the first set of signals for the data set using the Tx analog/RF chain. The UE 505 may calculate the transmit power based on the total Tx duration according to UWB regulations.

FIG. 8B is a diagram illustrating an example 820 associated with a repetition scheme associated with sidelink reception/transmission processing, in accordance with the present disclosure. As shown in FIG. 8B, example 820 may include repetitions in the frequency domain of a first data set 825 frequency multiplexed with a second data set 830. In some aspects, the component 820 of FIG. 8A may perform repetition over frequencies. For example, the relay UE 510 may append one or more repetitions of the first data set 825 and/or the second data set 830. In some aspects, the one or more repetitions include repetitions of received tones. The relay UE 510 may apply a scrambling sequence to each of the frequency resources, which in some aspects may be different for each repetition and/or resource.

In some aspects, the relay UE 510 may transmit the second data set 830 to the network entity 515 and may multiplex the first data set 825 and the second data set 830 on the one or more Uu link Tx chains. Each data set may be transmitted on a different layer. Example 820 shows the first data set 825 repetitions transmitted on Layer 1 and the second data set 830 repetitions transmitted on Layer 2.

As indicated above, FIGS. 8A and 8B are provided as examples. Other examples may differ from what is described with respect to FIGS. 8A and 8B.

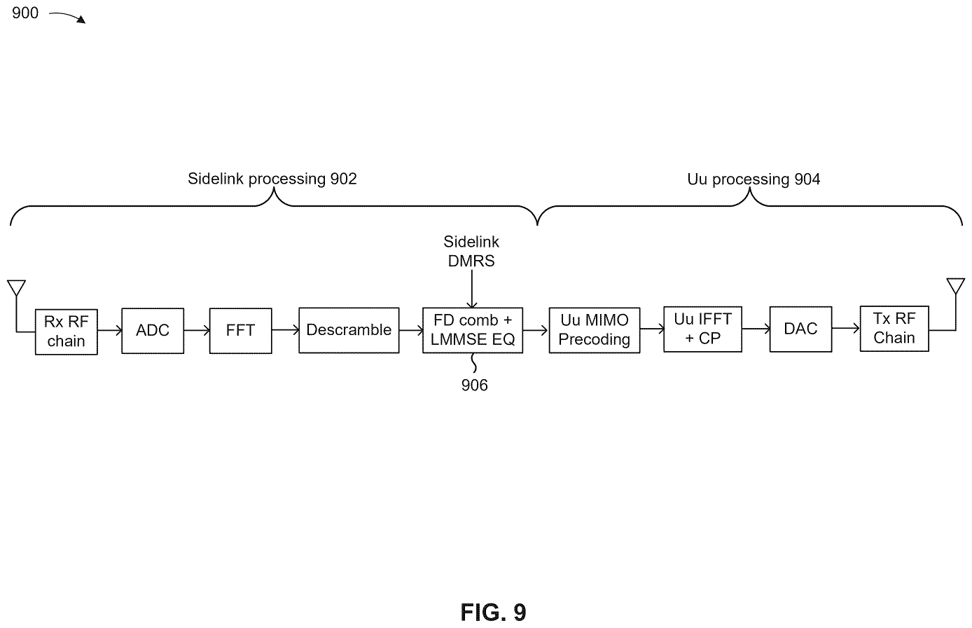

FIG. 9 is a diagram illustrating an example 900 associated with sidelink reception processing, in accordance with the present disclosure. As shown in FIG. 9, example 900 includes components for sidelink processing 902 and for Uu processing 904. Example 900 may include aspects of Rx chain 604 described in connection with FIG. 6, and may include additional aspects, such as repetition combination component 906, among other examples. In some aspects, the operations described with reference to FIG. 9 may be performed by components of a relay UE (e.g., relay UE 510) using UWB sidelink, as described herein in connection with FIGS. 5-8B.

The relay UE 510 may receive precoding information for sidelink repetitions at an Rx RF chain. The relay UE 510 may receive repetitions of a data set (second portion) at the Rx RF chain, which are then passed through an analog-to-digital converter (ADC) (to obtain digital samples of the data set) and an FFT component (to perform FFT using one or more parameters or numerologies for sidelink communications). Each repetition may be descrambled by a descramble component and input to the repetition combination component 906. The repetition combination component 906 may perform FD repetition combination (e.g., MRC repetition) of the repetitions and linear minimum mean squared error (LMMSE) equalization to minimize noise and interference. The combined repetitions may directly result in the data set (second portion). The Tx pre-equalization does not require channel estimation at the relay UE 510 side.

The relay UE 505 may then prepare the data set for forwarding. The relay UE 505 may perform Uu MIMO precoding (e.g., may receive data for all layers) using the precoding information from the UE 505 or other precoding information received from the network entity 515. The precoded signals may pass through a Uu IFFT and CP before being converted to analog signals by a DAC. For DFT-s-OFDM, the UE 505 is to obtain information for the tone mapping in the IFFT input buffer. The relay UE 505 may transmit at least one instance of the data set (second portion) to the network entity 515 using a Tx RF chain.

As indicated above, FIG. 9 is provided as an example. Other examples may differ from what is described with respect to FIG. 9.

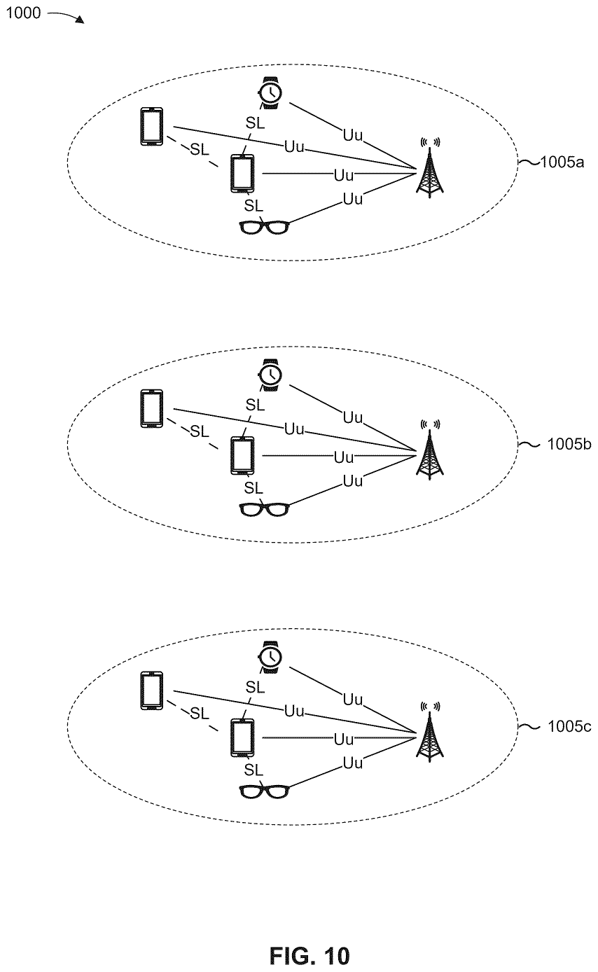

FIG. 10 is a diagram illustrating an example 1000 associated with FR2 and/or FR3 sidelink communications, in accordance with the present disclosure. As shown in FIG. 10, example 1000 includes a first network 1005a, a second network 1005b, and a third network 1005c, each of which may be an example of a small network as described in connection with FIG. 4 and/or may include aspects of wireless communication network 100 described in connection with FIG. 1. Each network 1000 may include one or more network entities (e.g., one or more network nodes 110 described in connection with FIG. 1), one or more companion devices (e.g., one or more companion devices 405a described in connection with FIG. 4 and/or relay UEs 510 described in connection with FIG. 5), and/or one or more primary UEs (e.g., one or more UEs 120 described in connection with FIG. 1, primary UE 410 described in connection with FIG. 4, and/or UE 505 described in connection with FIG. 5).

Sidelink over licensed bands (e.g., FR2 and/or FR3) may incorporate, in some examples, aspects of CV2X sidelink communications. However, sidelink over licensed bands may include many “small” networks (e.g., corresponding to each user), each comprising a small number of (e.g., ~2-4) devices (e.g., UEs, companion devices). Each of these networks may be associated with a small coverage area (e.g., 1-2 meters). However, because these small networks may be operating in parallel close to other small networks, the small networks, such as networks 1005, may interfere with each other.

To mitigate the effects of interference, licensed sidelink communications may have a PSD constraint (e.g., similarly to the UWB sidelink described in connection with reference number FIG. 3). Limiting PSD may mitigate interference with little or no network coordination due to an increased path loss at these frequencies, limited transmission power (e.g., because FR2 and/or FR3 frequency bands are relatively narrower than UWB), and/or user-specific scrambling associated with repetition generation and/or combination (e.g., similar to a spread spectrum signal).

As a result, in some aspects, sidelink over licensed bands (e.g., FR2 and/or FR3) may incorporate aspects of UWB sidelink, including data set repetition and sidelink reference signals (e.g., described in connection with FIGS. 8A, 8B, and 9) to generate a waveform with relatively low complexity and transmit power to satisfy PSD constraints while taking advantage of the increased channel throughput and/or data rates associated with sidelink over licensed bands. Additionally or alternatively, sidelink over licensed bands (e.g., FR2 and/or FR3) may incorporate allocation of resource pools (e.g., similarly to CV2X sidelink communications) to mitigate interference between relatively close users (e.g., in examples where the interference may not be sufficiently mitigated through PSD constraints and/or data set repetition described in connection with FIGS. 8A, 8B, and 9).

For example, networks 1005a, 1005b, and 1005c may be in close proximity to each other (“close” in this context may refer to a distance at which one network 1005 may interfere with another network 1005 using licensed frequency band communications). To avoid interference, each network 1005 may be allocated a different resource pool. However, because networks 1005a and 1005c are relatively further apart (e.g., further apart than networks 1005a and 1005b, and/or 1005b and 1005c), networks 1005a and 1005c may use a same resource pool with relatively low risk of interference impact.

As indicated above, FIG. 10 is provided as an example. Other examples may differ from what is described with respect to FIG. 10.

FIG. 11 is a diagram illustrating an example process 1100 performed, for example, at a UE or an apparatus of a UE. Example process 1100 is an example where the apparatus or the UE (e.g., UE 505) performs operations associated with reduced complexity signals for uplink.

As shown in FIG. 11, in some aspects, process 1100 may include transmitting, to a network entity via an access link, a first set of signals associated with a data set (block 1110). For example, the UE (e.g., using transmission component 1404 or communication manager 1406, depicted in FIG. 14) may transmit, to a network entity via an access link, a first set of signals associated with a data set, as described above in connection with FIGS. 5-10.

As further shown in FIG. 11, in some aspects, process 1100 may include transmitting, to a wireless device (e.g., companion device, relay UE 510) via a sidelink, precoding information and a second set of signals that includes a plurality of repetitions associated with the data set (block 1120). For example, the UE (e.g., using transmission component 1404 or communication manager 1406, depicted in FIG. 14) may transmit, to a wireless device via a sidelink, precoding information and a second set of signals that includes a plurality of repetitions associated with the data set, as described above in connection with FIGS. 5-10.

Process 1100 may include additional aspects, such as any single aspect or any combination of aspects described below or in connection with one or more other processes described elsewhere herein.

In a first aspect, transmitting the second set of signals includes transmitting the second set of signals using equalized tones.

In a second aspect, alone or in combination with the first aspect, transmitting the second set of signals includes transmitting the second set of signals layer-by-layer.

In a third aspect, alone or in combination with one or more of the first and second aspects, each repetition of the plurality of repetitions is at a different frequency.

In a fourth aspect, alone or in combination with one or more of the first through third aspects, each repetition of the plurality of repetitions is scrambled differently.

In a fifth aspect, alone or in combination with one or more of the first through fourth aspects, process 1100 includes generating, for each repetition of the plurality of repetitions, one or more DMRSs associated with combining the first set of signals and the second set of signals to obtain the data set.

In a sixth aspect, alone or in combination with one or more of the first through fifth aspects, the precoding information includes a PMI and sub-matrices.

In a seventh aspect, alone or in combination with one or more of the first through sixth aspects, process 1100 includes pre-equalizing the second set of signals.

In an eighth aspect, alone or in combination with one or more of the first through seventh aspects, the second set of signals includes a waveform that has a limited PSD in FR2 or FR3.

In a ninth aspect, alone or in combination with one or more of the first through eighth aspects, process 1100 includes transmitting an indication of a UE capability of using a wireless device via the sidelink to forward equalized tones over the access link in association with signal pairing.

In a tenth aspect, alone or in combination with one or more of the first through ninth aspects, process 1100 includes receiving a reference signal configuration, and transmitting a set of reference signals to the network entity.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a wireless device or an apparatus of a wireless device. Example process 1200 is an example where the apparatus or the wireless device (e.g., companion device, relay UE 510) performs operations associated with reduced complexity signals for uplink.

As shown in FIG. 12, in some aspects, process 1200 may include receiving precoding information (block 1210). For example, the wireless device (e.g., using reception component 1402 or communication manager 1406, depicted in FIG. 14) may receive precoding information, as described above in connection with FIGS. 5-10.

As further shown in FIG. 12, in some aspects, process 1200 may include receiving, from a UE via a sidelink, a set of signals that includes a plurality of repetitions of a data set (block 1220). For example, the wireless device (e.g., using reception component 1402 or communication manager 1406, depicted in FIG. 14) may receive, from a UE via a sidelink, a set of signals that includes a plurality of repetitions of a data set, as described above in connection with FIGS. 5-10.

As further shown in FIG. 12, in some aspects, process 1200 may include forwarding the set of signals to a network entity using the precoding information (block 1230). For example, the wireless device (e.g., using communication manager 1406, depicted in FIG. 14) may forward the set of signals to a network entity using the precoding information, as described above in connection with FIGS. 5-10.

Process 1200 may include additional aspects, such as any single aspect or any combination of aspects described below or in connection with one or more other processes described elsewhere herein.

In a first aspect, receiving the precoding information includes receiving precoding information from the UE.

In a second aspect, alone or in combination with the first aspect, receiving the precoding information includes receiving precoding information from the network entity.

In a third aspect, alone or in combination with one or more of the first and second aspects, transmitting the set of signals includes transmitting the set of signals using equalized tones.

In a fourth aspect, alone or in combination with one or more of the first through third aspects, transmitting the set of signals includes transmitting the set of signals layer-by-layer.

In a fifth aspect, alone or in combination with one or more of the first through fourth aspects, each repetition of the plurality of repetitions is scrambled differently.

In a sixth aspect, alone or in combination with one or more of the first through fifth aspects, process 1200 includes receiving a reference signal configuration, and transmitting a set of reference signals to the network entity.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, at a network entity or an apparatus of a network entity. Example process 1300 is an example where the apparatus or the network entity (e.g., network entity 515) performs operations associated with reduced complexity signals for uplink.

As shown in FIG. 13, in some aspects, process 1300 may include receiving, from a UE via an access link, a first set of signals associated with a data set (block 1310). For example, the network entity (e.g., using reception component 1502 or communication manager 1506, depicted in FIG. 15) may receive, from a UE via an access link, a first set of signals associated with a data set, as described above in connection with FIGS. 5-10.

As further shown in FIG. 13, in some aspects, process 1300 may include receiving, from a wireless device via a sidelink, a second set of signals that include a plurality of repetitions associated with the data set (block 1320). For example, the network entity (e.g., using reception component 1502 or communication manager 1506, depicted in FIG. 15) may receive, from a wireless device via a sidelink, a second set of signals that include a plurality of repetitions associated with the data set, as described above in connection with FIGS. 5-10.

As further shown in FIG. 13, in some aspects, process 1300 may include performing combined demodulation, based at least in part on precoding information, of the first set of signals and the second set of signals to generate the data set (block 1330). For example, the network entity (e.g., using communication manager 1506, depicted in FIG. 15) may perform combined demodulation, based at least in part on precoding information, of the first set of signals and the second set of signals to generate the data set, as described above in connection with FIGS. 5-10.

Process 1300 may include additional aspects, such as any single aspect or any combination of aspects described below or in connection with one or more other processes described elsewhere herein.

In a first aspect, process 1300 includes transmitting a reference signal configuration, receiving a set of reference signals, and transmitting the precoding information based at least in part on measurements of the set of reference signals.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication. The apparatus 1400 may be a UE, or a UE may include the apparatus 1400. In some aspects, the apparatus 1400 includes a reception component 1402, a transmission component 1404, or a communication manager 1406, which may be in communication with one another (for example, via one or more buses or one or more other components). In some aspects, the communication manager 1406 is the communication manager 150 described in connection with FIG. 1. As shown, the apparatus 1400 may communicate with another apparatus 1408, such as a UE or a network node (such as a CU, a DU, an RU, or a base station), using the reception component 1402 and the transmission component 1404. The communication manager 1406 may be included in, or implemented via, a processing system (for example, the processing system 140 described in connection with FIG. 1) of the UE.

In some aspects, the apparatus 1400 may be configured to perform one or more operations described herein in connection with FIGS. 1-10. Additionally, or alternatively, the apparatus 1400 may be configured to perform one or more processes described herein, such as process 1100 of FIG. 11, process 1200 of FIG. 12, or a combination thereof. In some aspects, the apparatus 1400 or one or more components shown in FIG. 14 may include one or more components of the UE described in connection with FIG. 1. Additionally, or alternatively, one or more components shown in FIG. 14 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications, and may provide the processed signals to the one or more other components of the apparatus 1400. In some aspects, the reception component 1402 may include one or more components of the UE described above in connection with FIG. 1, such as a radio, one or more RF chains, one or more transceivers, or one or more modems, each of which may in turn be coupled with one or more antennas of the UE.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications, and may transmit the processed signals to the apparatus 1408. In some aspects, the transmission component 1404 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1404 may be co-located with the reception component 1402.

The communication manager 1406 may support operations of the reception component 1402 or the transmission component 1404. For example, the communication manager 1406 may receive information associated with configuring reception of communications by the reception component 1402 or transmission of communications by the transmission component 1404. Additionally, or alternatively, the communication manager 1406 may generate or provide control information to the reception component 1402 or the transmission component 1404 to control reception or transmission of communications.

In some aspects associated with a UE (e.g., UE 505), the transmission component 1404 may transmit, to a network entity via an access link, a first set of signals associated with a data set. The transmission component 1404 may transmit, to a wireless device via a sidelink, precoding information and a second set of signals that includes a plurality of repetitions associated with the data set.

The communication manager 1406 may generate, for each repetition of the plurality of repetitions, one or more DMRSs associated with combining the first set of signals and the second set of signals to obtain the data set.

The communication manager 1406 may precode the second set of signals using the precoding information to pre-equalize the second set of signals. The transmission component 1404 may transmit an indication of a UE capability of using a wireless device via the sidelink to forward equalized tones over the access link in association with signal pairing.

The reception component 1402 may receive a reference signal configuration. The transmission component 1404 may transmit a set of reference signals to the network entity.

In some aspects associated with a wireless device (e.g., companion device, relay UE 510), the reception component 1402 may receive precoding information. The reception component 1402 may receive, from a UE via a sidelink using the precoding information, a set of signals that includes a plurality of repetitions of a data set. The communication manager 1406 may forward the set of signals to a network entity.

The reception component 1402 may receive a reference signal configuration. The transmission component 1404 may transmit a set of reference signals to the network entity.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication. The apparatus 1500 may be a network entity, or a network entity may include the apparatus 1500. In some aspects, the apparatus 1500 includes a reception component 1502, a transmission component 1504, or a communication manager 1506, which may be in communication with one another (for example, via one or more buses or one or more other components). In some aspects, the communication manager 1506 is the communication manager 155 described in connection with FIG. 1. As shown, the apparatus 1500 may communicate with another apparatus 1508, such as a UE or a network node (such as a CU, a DU, an RU, or a base station), using the reception component 1502 and the transmission component 1504. The communication manager 1506 may be included in, or implemented via, a processing system (for example, the processing system 145 described in connection with FIG. 1) of the network entity.

In some aspects, the apparatus 1500 may be configured to perform one or more operations described herein in connection with FIGS. 1-10. Additionally, or alternatively, the apparatus 1500 may be configured to perform one or more processes described herein, such as process 1300 of FIG. 13, or a combination thereof. In some aspects, the apparatus 1500 or one or more components shown in FIG. 15 may include one or more components of the network entity described in connection with FIG. 1. Additionally, or alternatively, one or more components shown in FIG. 15 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications, and may provide the processed signals to the one or more other components of the apparatus 1500. In some aspects, the reception component 1502 may include one or more components of the network entity described above in connection with FIG. 1, such as a radio, one or more RF chains, one or more transceivers, or one or more modems, each of which may in turn be coupled with one or more antennas of the network entity.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications, and may transmit the processed signals to the apparatus 1508. In some aspects, the transmission component 1504 may include one or more components of the network entity described above in connection with FIG. 1, such as a radio, one or more RF chains, one or more transceivers, or one or more modems, each of which may in turn be coupled with one or more antennas of the network entity described in connection with FIG. 1. In some aspects, the transmission component 1504 may be co-located with the reception component 1502.

The communication manager 1506 may support operations of the reception component 1502 or the transmission component 1504. For example, the communication manager 1506 may receive information associated with configuring reception of communications by the reception component 1502 or transmission of communications by the transmission component 1504. Additionally, or alternatively, the communication manager 1506 may generate or provide control information to the reception component 1502 or the transmission component 1504 to control reception or transmission of communications.

The reception component 1502 may receive, from a UE via an access link, a first set of signals associated with a data set. The reception component 1502 may receive, from a wireless device via a sidelink, a second set of signals that include a plurality of repetitions associated with the data set. The communication manager 1506 may perform combined demodulation, based at least in part on precoding information, of the first set of signals and the second set of signals to generate the data set.

The transmission component 1504 may transmit a reference signal configuration. The reception component 1502 may receive a set of reference signals. The transmission component 1504 may transmit the precoding information based at least in part on measurements of the set of reference signals.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by a user equipment (UE), comprising: transmitting, to a network entity via an access link, a first set of signals associated with a data set; and transmitting, to a wireless device via a sidelink, precoding information and a second set of signals that includes a plurality of repetitions associated with the data set.

Aspect 2: The method of Aspect 1, wherein transmitting the second set of signals includes transmitting the second set of signals using equalized tones.

Aspect 3: The method of any of Aspects 1-2, wherein transmitting the second set of signals includes transmitting the second set of signals layer-by-layer.

Aspect 4: The method of any of Aspects 1-3, wherein each repetition of the plurality of repetitions is at a different frequency.

Aspect 5: The method of any of Aspects 1-4, wherein each repetition of the plurality of repetitions is scrambled differently.

Aspect 6: The method of any of Aspects 1-5, further comprising generating, for each repetition of the plurality of repetitions, one or more demodulation reference signals associated with combining the first set of signals and the second set of signals to obtain the data set.

Aspect 7: The method of any of Aspects 1-6, wherein the precoding information includes a precoding matrix indicator (PMI) and sub-matrices.

Aspect 8: The method of any of Aspects 1-7, further comprising pre-equalizing the second set of signals.

Aspect 9: The method of any of Aspects 1-8, wherein the second set of signals includes a waveform that has a limited power spectral density in frequency range 2 or frequency range 3.

Aspect 10: The method of any of Aspects 1-9, further comprising transmitting an indication of a UE capability of using a wireless device via the sidelink to forward equalized tones over the access link in association with signal pairing.

Aspect 11: The method of any of Aspects 1-10, further comprising: receiving a reference signal configuration; and transmitting a set of reference signals to the network entity.

Aspect 12: A method of wireless communication performed by a wireless device, comprising: receiving precoding information; receiving, from a user equipment (UE) via a sidelink, a set of signals that includes a plurality of repetitions of a data set; and forwarding the set of signals to a network entity using the precoding information.

Aspect 13: The method of Aspect 12, wherein receiving the precoding information includes receiving precoding information from the UE.

Aspect 14: The method of any of Aspects 12-13, wherein receiving the precoding information includes receiving precoding information from the network entity.

Aspect 15: The method of any of Aspects 12-14, wherein transmitting the set of signals includes transmitting the set of signals using equalized tones.

Aspect 16: The method of any of Aspects 12-15, wherein transmitting the set of signals includes transmitting the set of signals layer-by-layer.

Aspect 17: The method of any of Aspects 12-16, wherein each repetition of the plurality of repetitions is scrambled differently.

Aspect 18: The method of any of Aspects 12-17, further comprising: receiving a reference signal configuration; and transmitting a set of reference signals to the network entity.

Aspect 19: A method of wireless communication performed by a network entity, comprising: receiving, from a user equipment (UE) via an access link, a first set of signals associated with a data set; receiving, from a wireless device via a sidelink, a second set of signals that include a plurality of repetitions associated with the data set; and perform combined demodulation, based at least in part on precoding information, of the first set of signals and the second set of signals to generate the data set.

Aspect 20: The method of Aspect 19, further comprising: transmitting a reference signal configuration; receiving a set of reference signals; and transmitting the precoding information based at least in part on measurements of the set of reference signals.

Aspect 21: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-20.

Aspect 22: An apparatus for wireless communication at a device, the apparatus comprising one or more memories and one or more processors coupled to the one or more memories, the one or more processors configured to cause the device to perform the method of one or more of Aspects 1-20.

Aspect 23: An apparatus for wireless communication, the apparatus comprising at least one means for performing the method of one or more of Aspects 1-20.

Aspect 24: A non-transitory computer-readable medium storing code for wireless communication, the code comprising instructions executable by one or more processors to perform the method of one or more of Aspects 1-20.

Aspect 25: A non-transitory computer-readable medium storing a set of instructions for wireless communication, the set of instructions comprising one or more instructions that, when executed by one or more processors of a device, cause the device to perform the method of one or more of Aspects 1-20.

Aspect 26: A device for wireless communication, the device comprising a processing system that includes one or more processors and one or more memories coupled with the one or more processors, the processing system configured to cause the device to perform the method of one or more of Aspects 1-20.

Aspect 27: An apparatus for wireless communication at a device, the apparatus comprising one or more memories and one or more processors coupled to the one or more memories, the one or more processors individually or collectively configured to cause the device to perform the method of one or more of Aspects 1-20.

Aspect 28: A device comprising a processing system that includes one or more processors and one or more code-storing memories coupled with the one or more processors, the processing system configured to cause the device to perform the method of one or more of Aspects 1-20.

Aspect 29: A device comprising a processing system that includes processor circuitry and code-storing memory circuitry, the processing system configured to cause the device to perform the method of one or more of Aspects 1-20.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
transmit, to a network entity via an access link, a first set of signals associated with a data set; and
transmit, to a wireless device via a sidelink, precoding information and a second set of signals that includes a plurality of repetitions associated with the data set.

2. The UE of claim 1, wherein the processing system, to cause the UE to transmit the second set of signals, is configured to cause the UE to transmit the second set of signals using equalized tones.

3. The UE of claim 1, wherein the processing system, to cause the UE to transmit the second set of signals, is configured to cause the UE to transmit the second set of signals layer-by-layer.

4. The UE of claim 1, wherein each repetition of the plurality of repetitions is at a different frequency.

5. The UE of claim 1, wherein each repetition of the plurality of repetitions is scrambled differently.

6. The UE of claim 1, wherein the processing system is configured to cause the UE to generate, for each repetition of the plurality of repetitions, one or more demodulation reference signals associated with combining the first set of signals and the second set of signals to obtain the data set.

7. The UE of claim 1, wherein the precoding information includes a precoding matrix indicator (PMI) and sub-matrices.

8. The UE of claim 1, wherein the processing system is configured to cause the UE to pre-equalize the second set of signals.

9. The UE of claim 1, wherein the second set of signals includes a waveform that has a limited power spectral density in frequency range 2 or frequency range 3.

10. The UE of claim 1, wherein the processing system is configured to cause the UE to transmit an indication of a UE capability of using a wireless device via the sidelink to forward equalized tones over the access link in association with signal pairing.

11. The UE of claim 1, wherein the processing system is configured to cause the UE to:
receive a reference signal configuration; and
transmit a set of reference signals to the network entity.

12. A wireless device, comprising:
a processing system that includes one or more processors and one or more code-storing memories coupled with the one or more processors, the processing system configured to cause the wireless device to:
receive precoding information;
receive, from a user equipment (UE) via a sidelink, a set of signals that includes a plurality of repetitions of a data set; and
forward the set of signals to a network entity using the precoding information.

13. The wireless device of claim 12, wherein the processing system, to cause the wireless device to receive the precoding information, is configured to cause the wireless device to receive precoding information from the UE.

14. The wireless device of claim 12, wherein the processing system, to cause the wireless device to receive the precoding information, is configured to cause the wireless device to receive precoding information from the network entity.

15. The wireless device of claim 12, wherein the processing system, to cause the wireless device to transmit the set of signals, is configured to cause the wireless device to transmit the set of signals using equalized tones.

16. The wireless device of claim 12, wherein the processing system, to cause the wireless device to transmit the set of signals, is configured to cause the wireless device to transmit the set of signals layer-by-layer.

17. The wireless device of claim 12, wherein each repetition of the plurality of repetitions is scrambled differently.

18. The wireless device of claim 12, wherein the processing system is configured to cause the wireless device to:
receive a reference signal configuration; and
transmit a set of reference signals to the network entity.

19. A network entity, comprising:
a processing system that includes one or more processors and one or more code-storing memories coupled with the one or more processors, the processing system configured to cause the network entity to:
receive, from a user equipment (UE) via an access link, a first set of signals associated with a data set;
receive, from a wireless device via a sidelink, a second set of signals that include a plurality of repetitions associated with the data set; and
perform combined demodulation, based at least in part on precoding information, of the first set of signals and the second set of signals to generate the data set.

20. The network entity of claim 19, wherein the processing system is configured to cause the network entity to:
transmit a reference signal configuration;
receive a set of reference signals; and
transmit the precoding information based at least in part on measurements of the set of reference signals.
